(19) United States
(12) Patent Application Publication
(10) Pub. No.: US 2017/0130877 A1
(43) Pub. Date: May 11, 2017

(54) PIPE CONNECTOR

(71) Applicant: Actuant Corporation, Menomonee Falls, WI (US)

(72) Inventor: David Barker, Staffordshire (GB)

(21) Appl. No.: 15/410,464

(22) Filed: Jan. 19, 2017

Related U.S. Application Data
(63) Continuation-in-part of application No. PCT/US2015/048116, filed on Sep. 2, 2015.
(60) Provisional application No. 62/281,588, filed on Jan. 21, 2016.
(60) Provisional application No. 62/174,771, filed on Jun. 12, 2015.
(60) Provisional application No. 62/044,678, filed on Sep. 2, 2014.

(51) Int. Cl. F16L 19/00; F16L 19/06

(52) U.S. Cl. CPC F16L 19/005; F16L 19/06

(57) ABSTRACT

A pipe connector for connecting pipes in a pipeline. The connector may include an outer body defining a cavity; a gripping ring supported in the cavity, the gripping ring defining a gap to allow the gripping ring to decrease in diameter to engage one of the pipes, a pin releasably positioned in the gap for selectively maintaining the gap, an end nut defining a nut bore receiving the gripping ring, and a seal supported in the cavity. The end nut being configured to move axially inwardly relative to the outer body to compress the seal and cause at least the first gripping ring to engage the one of the pipes upon release of the pin.

### RELATED APPLICATIONS

This application claims priority to and is a continuation-in-part of co-pending, prior-filed PCT Patent Application No. PCT/US2015/048116, filed Sep. 2, 2015, which claims the benefit of U.S. Provisional Patent Application Nos. 62/174,771, filed Jun. 12, 2015, and 62/044,678, filed Sep. 2, 2014, and also claims priority to co-pending, prior-filed U.S. Provisional Patent Application No. 62/281,588, filed Jan. 21, 2016, the entire contents of all of which are incorporated by reference.

### FIELD

The present invention relates to pipeline connectors and, more particularly, to top-side mechanical pipeline connectors.

### SUMMARY

Top-side mechanical pipeline connectors are often used to connect pipelines that transport various fluids (e.g., water, waste, drainage, etc.) or are used for venting purposes. Various small pipeline connectors exist using several methods of pipe gripping, such as swaging, biting, pressing, flaring, machine grooved, and slit type methods. However, these gripping methods may involve deforming or machining the pipe such that the pipe would be permanently changed in shape.

In one independent aspect, a pipe connector for connecting pipes in a pipeline may be provided. The connector may generally include an outer body defining a cavity; a gripping ring supported in the cavity, the gripping ring defining a gap to allow the gripping ring to decrease in diameter; and an end nut defining a nut bore receiving the gripping ring, a nut engagement surface extending into the nut bore and being engageable with the gripping ring, the end nut being configured to move axially inwardly relative to the outer body to compress and cause the gripping ring to engage one of the pipes.

In another independent aspect, a method of assembling a pipe connector to at least one pipe in a pipeline may be provided. The connector may include an outer body defining a cavity, a gripping ring supported in the cavity, the gripping ring defining a gap, and an end nut defining a nut bore receiving the gripping ring, a nut engagement surface extending into the nut bore and being engageable with the gripping ring. The method may generally include inserting a first pipe into the connector; and moving the end nut axially inwardly relative to the outer body to compress and cause the gripping ring to engage the at least one first pipe.

In yet another independent aspect, a method of assembling a pipe connector may be provided. The connector may include an outer body defining a cavity and providing a radial surface extending into the cavity, a gripping ring supported in the cavity, the gripping ring defining a gap, an end nut defining a nut bore receiving the gripping ring, a nut engagement surface extending into the nut bore and being engageable with the gripping ring, a pin positionable in the gap to selectively prevent compression of the gripping ring, a seal in the cavity between the radial surface and the end nut, and a seal ram supported in the cavity, the seal ram extending at least partially into the nut bore. The method may generally include inserting a first pipe into the connector; moving the end nut axially inwardly relative to the outer body to cause the gripping ring to engage the seal ram without compressing the gripping ring toward the first pipe; moving the seal ram axially inwardly relative to the outer body by axial inward movement of the end nut to compress the seal between a component of the connector and the first pipe; thereafter, removing the pin from the gap; and, thereafter, moving the end nut axially inwardly relative to the outer body to compress and cause the gripping ring to engage the first pipe.

In a further independent aspect, a pipe connector may generally include an outer body defining a cavity and providing a radial surface extending into the cavity; a gripping ring supported in the cavity, the gripping ring having a first end and second end defining a gap to allow the gripping ring to decrease in diameter to engage one of the pipes; a pin dimensioned and configured to substantially extend from the first end of the gripping ring to the second end of the gripping ring when positioned in the gap, the pin selectively preventing substantial compression of the gripping ring; an end nut defining a nut bore receiving the gripping ring, a nut engagement surface extending into the nut bore and being engageable with the gripping ring, the end nut being configured to move axially inwardly relative to the outer body to compress the gripping ring; a seal in the cavity between the radial surface and the end nut, the seal being engageable between a component of the connector and the one of the pipes; and a seal ram supported in the cavity, the seal ram extending at least partially into the nut bore, axial inward movement of the end nut causing axial inward movement of the seal ram to compress the seal.

In some embodiments, the pin has a first end in engagement with the first end of the gripping ring and a second end in engagement with the second end of the gripping ring, the first and second ends of the pin being configured to reduce contact with the gripping ring. In further embodiments, the first end and the second end of the pin can be curved. More specifically, in some embodiments, the pin has a main body portion extending between the first end and the second end of the pin, the main body portion being rectangular in shape and the first and second ends of the pin being semi-circular.

In another independent aspect, a method of assembling a pipe connector to at least one pipe in a pipeline may be provided. The connector may include an outer body defining a cavity and providing a radial surface extending into the cavity, a gripping ring supported in the cavity, the gripping ring defining a gap, an end nut defining a nut bore receiving the gripping ring, a nut engagement surface extending into the nut bore and being engageable with the gripping ring, a selectively removeable pin extending across the gap to selectively prevent compression of the gripping ring, a seal in the cavity between the radial surface and the end nut, and a seal ram supported in the cavity, the seal ram extending at least partially into the nut bore. The method may generally include inserting a first pipe into the connector; moving the end nut axially inwardly relative to the outer body to cause the gripping ring to engage the seal ram without compressing the gripping ring toward the first pipe; and moving the seal ram axially inwardly relative to the outer body by axial inward movement of the end nut to compress the seal between a component of the connector and the first pipe; thereafter, removing the pin from the gap; and, thereafter, moving the end nut axially inwardly relative to the outer body to compress and cause the gripping ring to engage the first pipe.

In yet another independent aspect, a pipe connector may generally include an outer body defining a cavity; a first gripping ring supported in the cavity, the first gripping ring defining a scarf cut to allow the first gripping ring to decrease in diameter to engage one of the pipes; a second gripping ring proximate the first gripping ring; and an end nut defining a nut bore receiving the first gripping ring and the second gripping ring, a nut engagement surface extending into the nut bore and being engageable with the first gripping ring, the end nut being configured to move axially inwardly relative to the outer body to compress and cause at least the first gripping ring to engage the one of the pipes.

In a further independent aspect, a pipe connector may generally include an outer body defining a cavity and providing a radial surface extending into the cavity; a gripping ring supported in the cavity, the gripping ring defining a scarf cut to allow the gripping ring to decrease in diameter to engage one of the pipes; an end nut defining a nut bore receiving the gripping ring, a nut engagement surface extending into the nut bore and being engageable with the gripping ring, the end nut being configured to move axially inwardly relative to the outer body to compress the gripping ring; a seal in the cavity between the radial surface and the end nut, the seal being engageable between a component of the connector and the one of the pipes; and a seal ram supported in the cavity, the seal ram extending at least partially into the nut bore, axial inward movement of the end nut causing axial inward movement of the seal ram to compress the seal.

In another independent aspect, a method of assembling a pipe connector may be provided. The connector may include an outer body defining a cavity, a first gripping ring supported in the cavity, the first gripping ring defining a scarf cut, a second gripping ring proximate the first gripping ring, and an end nut defining a nut bore receiving the first gripping ring and the second gripping ring, a nut engagement surface extending into the nut bore and being engageable with the first gripping ring. The method may generally include inserting a first pipe into the connector; and moving the end nut axially inwardly relative to the outer body to compress and cause at least the first gripping ring to engage the first pipe.

In yet another independent aspect, a method of assembling a pipe connector may be provided. The connector may include an outer body defining a cavity and providing a radial surface extending into the cavity, a gripping ring supported in the cavity, the gripping ring defining a scarf cut, an end nut defining a nut bore receiving the gripping ring, a nut engagement surface extending into the nut bore and being engageable with the gripping ring, a seal in the cavity between the radial surface and the end nut, and a seal ram supported in the cavity, the seal ram extending at least partially into the nut bore. The method may generally include inserting a first pipe into the connector; moving the end nut axially inwardly relative to the outer body to compress and cause the gripping ring to engage the first pipe; and moving the seal ram axially inwardly relative to the outer body by axial inward movement of the end nut to compress the seal between a component of the connector and the first pipe.

In a further independent aspect, a pipe connector may generally include an outer body defining a cavity; a gripping ring supported in the cavity, the gripping ring defining a gap to allow the gripping ring to decrease in diameter to engage one of the pipes; and an end nut defining a nut bore receiving the gripping ring, a nut engagement surface extending into the nut bore and being engageable with the gripping ring, the end nut being configured to move axially inwardly relative to the outer body to compress and cause the gripping ring to engage the one of the pipes.

In another independent aspect, a pipe connector may generally include an outer body defining a cavity and providing a radial surface extending into the cavity; a gripping ring supported in the cavity, the gripping ring defining a gap to allow the gripping ring to decrease in diameter to engage one of the pipes; an end nut defining a nut bore receiving the gripping ring, a nut engagement surface extending into the nut bore and being engageable with the gripping ring, the end nut being configured to move axially inwardly relative to the outer body to compress the gripping ring; a seal in the cavity between the radial surface and the end nut, the seal being engageable between a component of the connector and the one of the pipes; and a seal ram supported in the cavity, the seal ram extending at least partially into the nut bore, axial inward movement of the end nut causing axial inward movement of the seal ram to compress the seal.

In yet another independent aspect, a pipe connector may generally include an outer body defining a cavity; a gripping ring supported in the cavity, the gripping ring defining a gap to allow the gripping ring to decrease in diameter to engage one of the pipes; an end nut defining a nut bore receiving the gripping ring, a nut engagement surface extending into the nut bore and being engageable with the gripping ring, the end nut being configured to move axially inwardly relative to the outer body to compress and cause the gripping ring to engage the one of the pipes; and a pin movably positioned in the gap to limit compression of the gripping ring during movement of the end nut.

In a further independent aspect, a method of assembling a pipe connector may be provided. The connector may include an outer body defining a cavity, a gripping ring supported in the cavity, the gripping ring defining a gap, and an end nut defining a nut bore receiving the gripping ring, a nut engagement surface extending into the nut bore and being engageable with the gripping ring. The method may generally include inserting a first pipe into the connector; and moving the end nut axially inwardly relative to the outer body to compress and cause the gripping ring to engage the first pipe.

In another independent aspect, a method of assembling a pipe connector may be provided. The connector may include an outer body defining a cavity and providing a radial surface extending into the cavity, a gripping ring supported in the cavity, the gripping ring defining a gap, an end nut defining a nut bore receiving the gripping ring, a nut engagement surface extending into the nut bore and being engageable with the gripping ring, a seal in the cavity between the radial surface and the end nut, and a seal ram supported in the cavity, the seal ram extending at least partially into the nut bore. The method may generally include inserting a first pipe into the connector; moving the end nut axially inwardly relative to the outer body to compress and cause the gripping ring to engage the first pipe; and moving the seal ram axially inwardly relative to the outer body by axial inward movement of the end nut to compress the seal between a component of the connector and the first pipe.

In yet another independent aspect, a method of assembling a pipe connector may be provided. The connector may include an outer body defining a cavity and providing a radial surface extending into the cavity, a gripping ring supported in the cavity, the gripping ring defining a gap, an end nut defining a nut bore receiving the gripping ring, a nut engagement surface extending into the nut bore and being engageable with the gripping ring, a pin movably positioned in the gap, a seal in the cavity between the radial surface and the end nut, and a seal ram supported in the cavity, the seal ram extending at least partially into the nut bore. The method may generally include inserting a first pipe into the connector; moving the end nut axially inwardly relative to the outer body to cause the gripping ring to engage the pin to limit compression of the gripping ring toward the first pipe; and moving the seal ram axially inwardly relative to the outer body by axial inward movement of the end nut to compress the seal between a component of the connector and the first pipe; thereafter, removing the pin from the gap; and, thereafter, moving the end nut axially inwardly relative to the outer body to compress and cause the gripping ring to engage the first pipe.

Independent features and independent advantages of the invention will become apparent to those skilled in the art upon review of the detailed description, drawings and claims.

### BRIEF DESCRIPTION OF DRAWINGS

FIG. 1 is a cross-sectional view of a pipe connector in accordance with an embodiment of the invention.

FIG. 2 is an exploded view of the pipe connector of FIG. 1, illustrating components from both sides of the pipe connector.

FIG. 3 is an exploded view of the pipe connector of FIG. 1, illustrating components from a single side of the pipe connector.

FIG. 4 is a cross-sectional view of the pipe connector of FIG. 1.

FIG. 5 is a cross-sectional view of a portion of the pipe connector of FIG. 1, illustrating the gap between an end nut and an outer body at a maximum distance.

FIG. 6 is a cross-sectional view of a portion of the pipe connector of FIG. 1, illustrating the gap between the end nut and the outer body at a reduced distance.

FIG. 7 is a cross-sectional view of a portion of the pipe connector of FIG. 1, illustrating the gap between the end nut and the outer body at a further reduced distance corresponding to a desired activation gap size.

FIG. 8 is a cross-sectional view of a portion of the pipe connector of FIG. 1 installed in a pipeline, illustrating the pressure test port.

FIG. 9 is multiple perspective views of various components of a hand-held external activation system used to activate the pipe connector of FIG. 1.

FIG. 10 is multiple perspective views of the pipe connector of FIG. 1 in combination with the hand-help external activation system of FIG. 9 at various stages of installation.

FIG. 11 is multiple perspective views of the pipe connector of FIG. 1 in combination with the hand-help external activation system of FIG. 9 at various stages of installation.

FIG. 12 is a cross-sectional view of a portion of the pipe connector of FIG. 1 installed in a pipeline, illustrating the pressure test port.

FIG. 13 is a cross-sectional view of a pipe connector in accordance with an alternative embodiment of the invention.

FIG. 14 is a cross-sectional view of the pipe connector of FIG. 13, illustrating the pipe connector in engagement with two connected pipes.

FIG. 15 is a cross-sectional view of a portion of the pipe connector of FIG. 13, illustrating the gap between a gripping sleeve and a seal sleeve at a maximum distance.

FIG. 16 is a cross-sectional view of a portion of the pipe connector of FIG. 13, illustrating the gap between the gripping sleeve and the seal sleeve at a reduced distance.

FIG. 17 is a cross-sectional view of a portion of the pipe connector of FIG. 13, illustrating the gap between the gripping sleeve and the seal sleeve at a further reduced distance corresponding to a desired activation gap size.

FIG. 18 is a cross-sectional view of a portion of the pipe connector of FIG. 13, illustrating the pressure test port.

FIGS. 19A-19C illustrate various views of a gripping ring.

FIG. 20 is an exploded view of a pipe connector including the gripping ring shown in FIGS. 19A-19C.

FIG. 21 is a cross-sectional view of the pipe connector of FIG. 20.

FIG. 22 is a cross-sectional view of the pipe connector of FIG. 20.

FIG. 23 is a cross-sectional view of a portion of the pipe connector of FIG. 20, illustrating the gap between an end nut and an outer body at a maximum distance.

FIG. 24 is a cross-sectional view of a portion of the pipe connector of FIG. 20, illustrating the gap between the end nut and the outer body at a reduced distance.

FIG. 25 is a cross-sectional view of a portion of the pipe connector of FIG. 20, illustrating the gap between the end nut and the outer body at a further reduced distance corresponding to a desired activation gap size.

FIG. 26 is a cross-sectional view of a portion of the pipe connector of FIG. 20 installed in a pipeline, illustrating the pressure test port.

FIG. 27 is a perspective cross-sectional view of a pipe connector in accordance with another alternative embodiment of the invention.

FIGS. 28A-28B are views of a portion of the pipe connector of FIG. 27 prepared for installation.

FIGS. 29A-29B are views of the portion of the pipe connector of FIG. 27 after initial turning of the end nut.

FIG. 30 is a perspective cross-sectional view of the portion of the pipe connector of FIG. 27 after continued turning of the end nut.

FIG. 31 is a perspective cross-sectional view of the portion of the pipe connector of FIG. 27 with the pin removed.

FIGS. 32A-32B are views of the portion of the pipe connector of FIG. 27 after further turning of the end nut.

FIG. 33 is a perspective view of a gripping ring of the pipe connector of FIG. 27.

FIGS. 34A-34E are views of a portion of the pipe connector of FIG. 27.

FIG. 35 is a perspective view of an alternative construction of an end nut, a gripping ring and dowel pins.

FIG. 36 is a cross-sectional view of a pipe connector in accordance with another alternative embodiment of the invention.

FIG. 37 is a partial end view of the pipe connector of FIG. 36.

FIG. 38 is a perspective view of the pipe connector of FIG. 36

FIGS. 39A-39D are views of a portion of the pipe connector of FIG. 36 in various stages of installation.

FIGS. 40A-40B are views of a portion of the pipe connector illustrating yet another pin arrangement.

FIG. 41 is a view of a portion of the pipe connector illustrating yet another pin arrangement.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting.

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof.

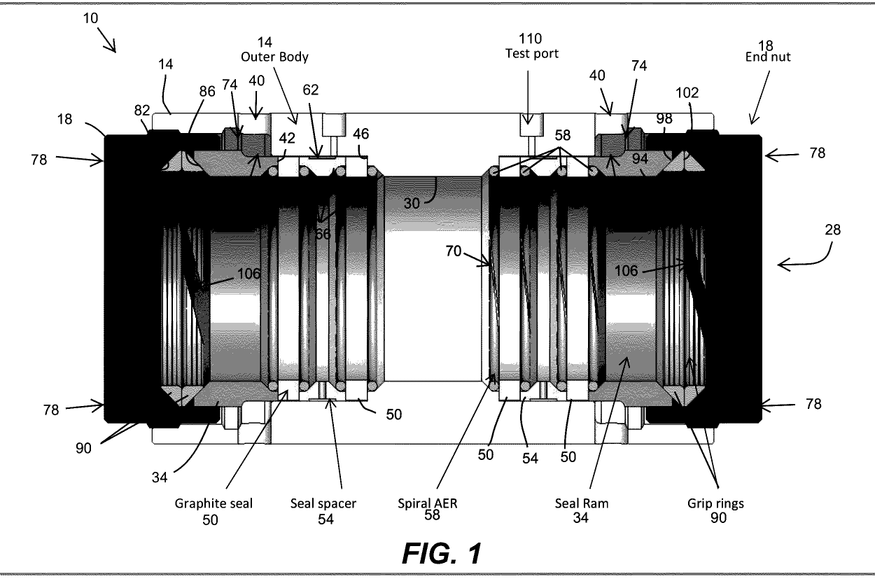

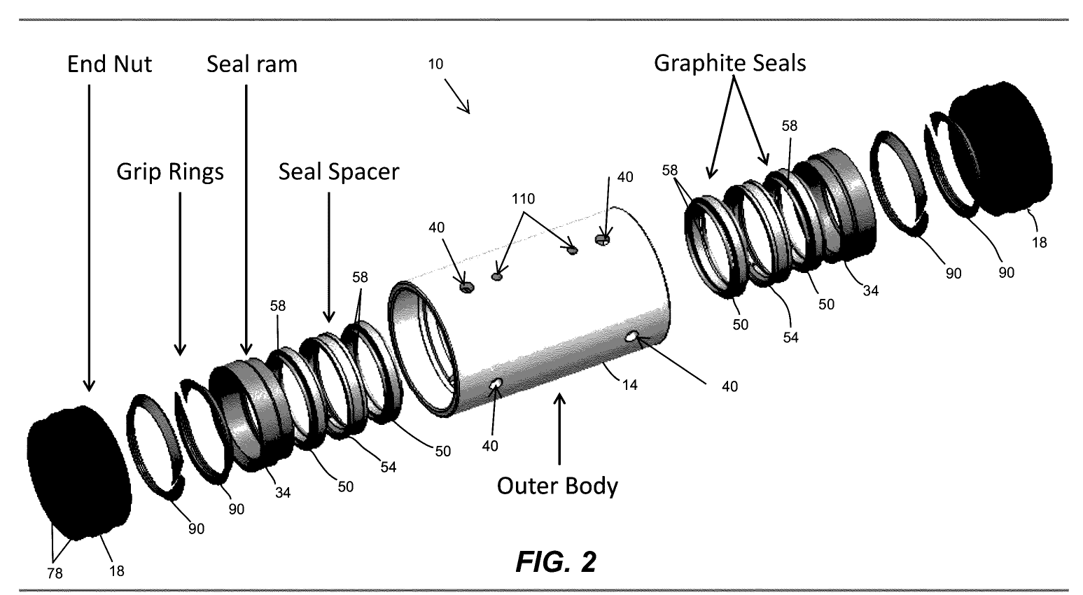

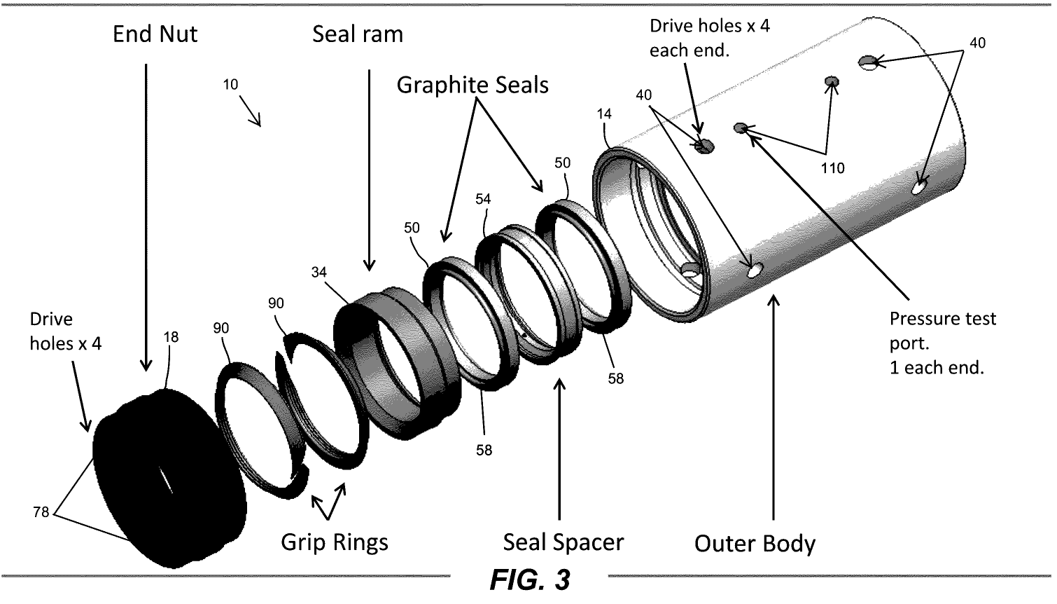

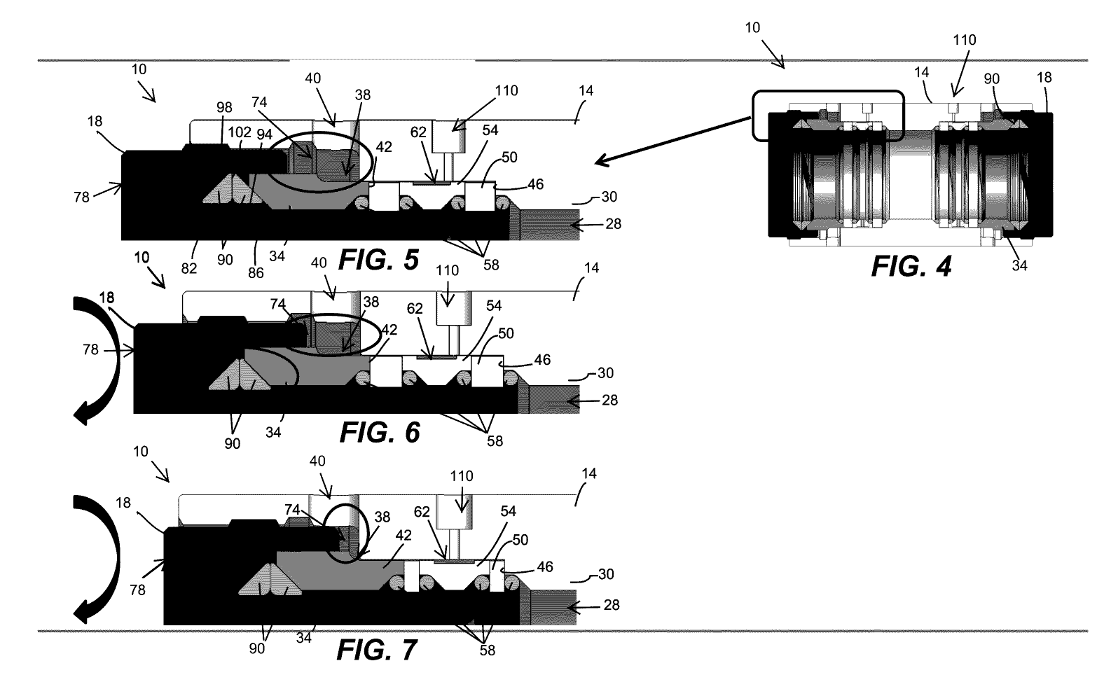

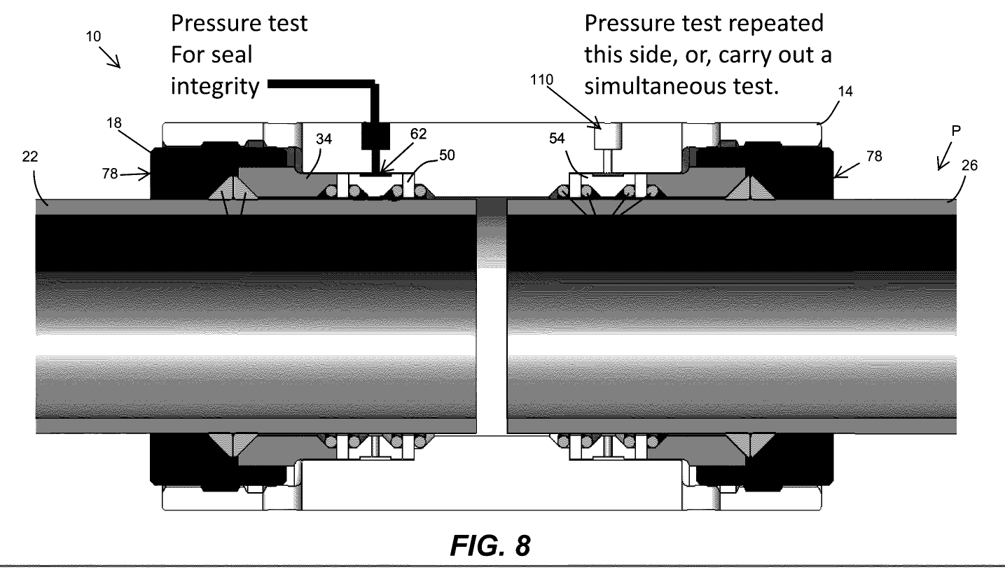

FIGS. 1-4 illustrate a grip-lock pipeline connector 10 in accordance with an embodiment of the invention. The illustrated connector 10 is substantially symmetric about a center vertical axis, with respect to FIG. 1, and any feature or element referenced on one side connector 10 equally pertains to the mirrored feature or elements on the other side of the connector 10. As an example, the connector 10 may be for above ground use on pipelines P (FIG. 8) in the range of 1 inch to 4 inches and having a pressure rating of about class 150 (i.e., 31 bar). In some embodiments, the connector 10 may have a pressure rating of about class 300 (i.e., 78 bar).

The connector 10 includes an outer body 14 and a pair of end nuts 18 that move axially (i.e., along the longitudinal axis of the connector 10) inwardly and outwardly with respect to the body 14 for compressing various components held within a cavity defined by the connector 10. The connector 10 is configured to grip onto and fluidly connect a first pipe 22 and a second pipe 26 (FIG. 8) of a pipeline P. The end nuts 18 and other various other components of the connector 10 to be described below each define a cylindrical opening or bore 28 for receiving the end portions of the pipes 22, 26.

The body 14 has a center abutment 30 protruding into the cavity near the middle. A seal sleeve or ram 34 is positioned on each side of the abutment 30, and gaps 38 are defined between opposite portions of the abutment 30 and the seal rams 34. The seal rams 34 are movable inwardly with respect to the body 14 (i.e., toward the abutment 30) to reduce the size of the gaps 38. The body 14 defines a plurality of outer body drive holes 40.

While referred to as a “center abutment”, the abutment 30 does not necessarily provide a reaction surface against which one of the pipes 22, 26 engages. The center abutment 30 generally guides and centralizes the pipes 22, 26 and has a width to accommodate an open tolerance for pipe insertion. For example, FIG. 8 illustrates that the ends of the pipes 22, 26 do not need to engage a reaction surface of the abutment 30, or each other, but can be provided in a spaced relationship within a region defined by the center abutment 30.

The abutment 30 and the seal rams 34 each include an engagement surface 42, 46, respectively, to compress, therebetween a number of seals (e.g., two seals 50) when the seal rams 34 are moved axially inwardly. The multiple seals 50 are axially spaced apart by seal spacers 54 and scarfed, wire-type, anti-extrusion rings 58 (AERs). A void 62 is defined axially between the seals 50 (e.g., in the seal spacer 54) on each side of the abutment 30.

When the seal rams 34 move axially inwardly (i.e., toward the abutment 30), the material of the seals 50 compresses and is forced radially inwardly to engage the outer surface of the associated pipe 22, 26 to form a pressure tight seal. When compressed axially, the seal 50 extrudes radially inwardly and outwardly to provide a seal between the exterior surface of the associated pipe 22, 26 and a component of the connector 10 (e.g., the inner surface of the body 14 in the illustrated construction).

The illustrated seals 50 are of the type used in the commercially available line of engineered mechanical subsea connectors manufactured by Hydratight Limited. The seal 50 may be, for example, 98% pure exfoliated graphite. The seal 50 may include a laminate graphite sheet and/or be ribbon spun or spiral-wound around a mandrel into a mold that can be subsequently manipulated into a suitable construction (e.g., size, shape, etc.) for the connector 10. In other constructions, the seal 50 may include any of a variety of other seal packing materials.

In the illustrated construction, the seals 50 are prevented from extruding into gaps between the pipes 22, 26 and adjacent components of the connector 10 by the anti-extrusion rings 58, which can close down onto (i.e., move radially inwardly with respect to) the pipes 22, 26. Specifically, components (e.g., the abutment 30, the seal spacers 54, and the seal rams 34) adjacent the rings 58 include slanted engagement surfaces 66, which function as ramps to direct the rings 58 radially inwardly.

As the seals 50 and, more specifically, the top portion of the seals 50, are compressed, the bottom portions of the seals 50 expand. This forces the rings 58 into further engagement with the slanted surfaces 66, which directs the rings 58 radially inwardly. The rings 58 include a spiral or scarf cut 70 such that they are able to contract (i.e., decrease in diameter) or expand (i.e., increase in diameter) without plastically deforming.

The illustrated seal rams 34 are at least partially received by an opening defined by the end nuts 18. Gaps 74 are defined between opposite portions of the body 14 and the end nuts 18. The gaps 74 allow the end nuts 18 to move inwardly with respect to body 14 (i.e., toward the seal rams 34 and abutment 30) to reduce the size of the gaps 74. To facilitate this inward movement, the end nuts 18 include a plurality of drive holes 78 and a threaded region engaging a complementary threaded region of the body 14. The illustrated end nuts 18 may be moved axially inwardly by means of turning or rotating the end nuts 18 in a controlled manner.

The end nuts 18 and the seal rams 34 each include slanted engagement surfaces 82, 86, respectively. When the end nuts 18 are moved axially inwardly, the engagement surfaces 82, 86 compress therebetween a number of gripping rings (e.g., two gripping rings 90 in the illustrated construction), at least some of which are located at least partially within the opening defined by the associated end nut 18. The engagement surfaces 82, 86 may be coated with a dry film lubricant to assist in reducing contact friction when in contact with the gripping rings 90.

Each illustrated gripping ring 90 has a generally triangular cross-section with a radial inner surface 94, a sloped surface 98, and a surface 102 extending transverse to the longitudinal axis facing and engaged by the inner surface 102 of the adjacent gripping ring 90. The radial inner surface 94 of the gripping rings 90 may be profiled (i.e., formed with slits, grooves, bumps, etc.) to effect greater gripping capacity. The gripping rings 90 also include a spiral or scarf cut 106 such that they are able to contract (i.e., reduce in diameter) or expand (i.e., increase in diameter). In some embodiments, the gripping ring 90 may be able to expand and contract without plastically deforming. The inner surface(s) 102 may also be coated with a dry film lubricant to assist in reducing contact friction when the gripping rings 90 contract or expand.

To direct the gripping rings 90 radially inwardly, the slanted engagement surfaces 82, 86 function as ramps in a similar fashion to the engagement surfaces 66. When the end nuts 18 move axially inwardly (i.e., toward the abutment 30), the engagement surfaces 82, 86 engage the sloped surfaces 98 of the gripping rings 90 to compress the rings 90. The rings 90 are forced radially inwardly to engage and conform to the outer surface of the associated pipe 22, 26, to hold the connector 10 in engagement with the pipes 22, 26.

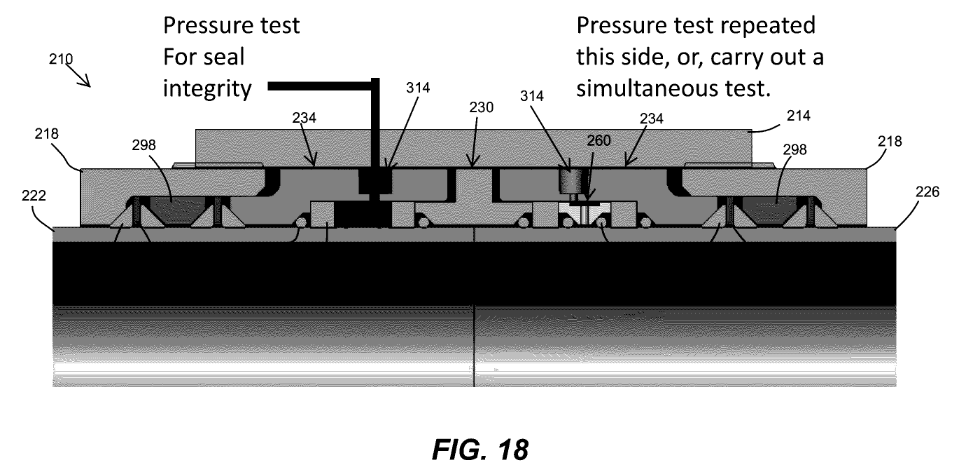

With respect to FIG. 8, the connector 10 also includes at least one threaded pressure test port 110. To confirm that the connector 10 has been installed correctly, the void 62 between each seal 50, at each end of the connector 10, can be accessed by the pressure test port 110 and pressurized to a desired hydraulic pressure. The seal spacers 54 may include a hole (see e.g., FIG. 18) to allow the fluid to pass from the void 62 to the volume between the seal spacers 54 and the pipes 22, 26 to more completely fill the gaps between the seals 50. This ensures the seals 50 are pressurized where the seals 50 come into contact with the pipe 22, 26. The hydraulic pressure is held for an appropriate length of time to confirm the seal integrity and gripping capacity of the connector 10 as a whole.

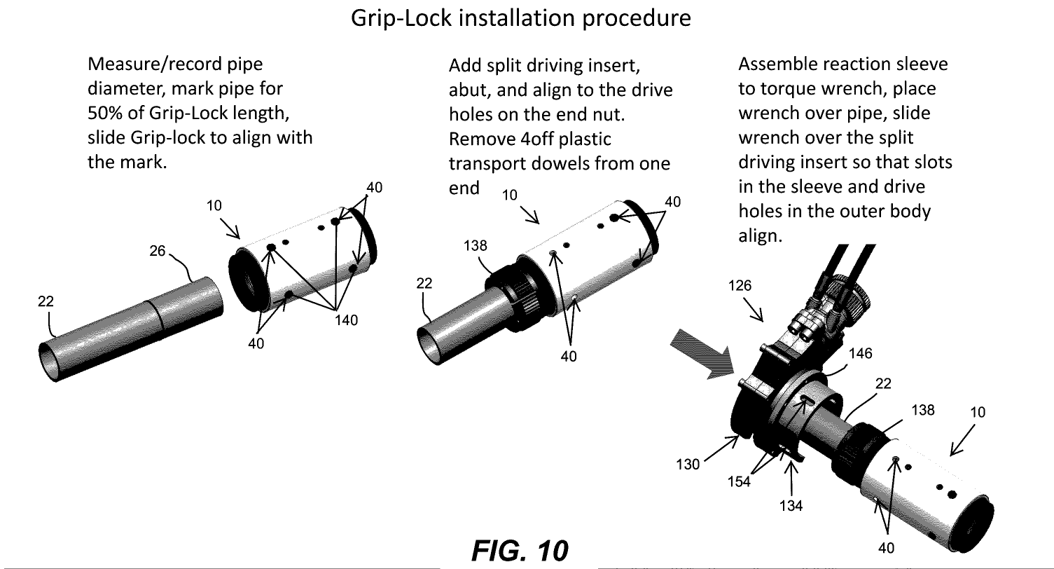

In FIG. 1, the connector 10 is illustrated in a condition for assembly with the pipeline P. To assemble, the ends of the pipes 22, 26 are slid into the bore 28 of the connector 10 (FIG. 10). When the pipes 22, 26 are inserted into the bore 28, the gaps 38, 74 are at their maximum separation distance (FIG. 5) with none of the components of the connector 10 (e.g., gripping rings 90, anti-extrusion rings 58, etc.) directed radially inwardly (i.e., into the bore 28) and the bore 28 fully opened to receive the pipes 22, 26 without causing damage to either the pipes 22, 26 or the connector 10. The connector 10 is then activated by a hand-held external activation system to grip onto the pipe by the internal gripping rings 90.

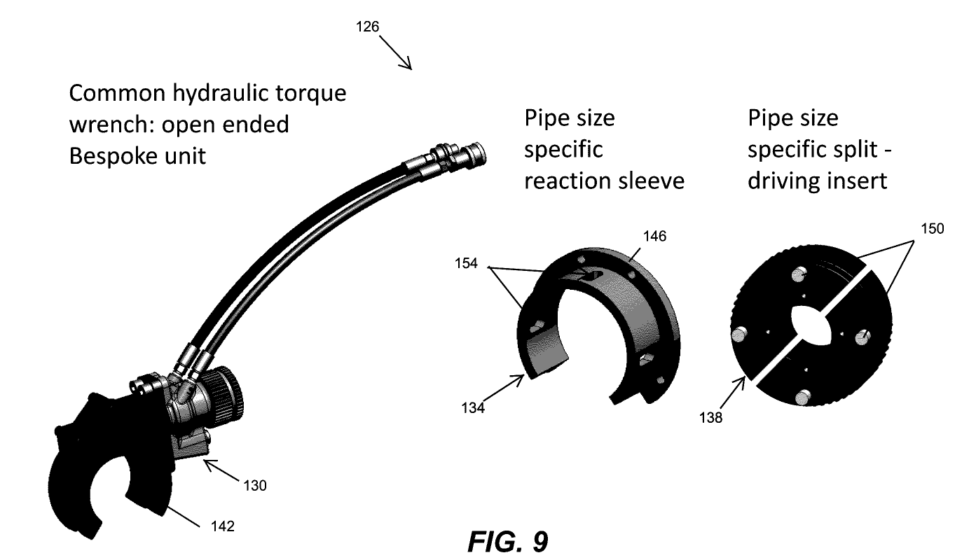

FIG. 9 illustrates an exemplary external system 126 used to activate the connector 10. The external activation system 126 includes a torque wrench 130, a reaction sleeve 134, and a split driving insert 138. The torque wrench 130 has an attachment surface 142 for coupling to a flange 146 of the reaction sleeve 134. The split driving insert 138 includes a plurality of protruding pins 150 for engaging the drive holes 78 of each end nut 18.

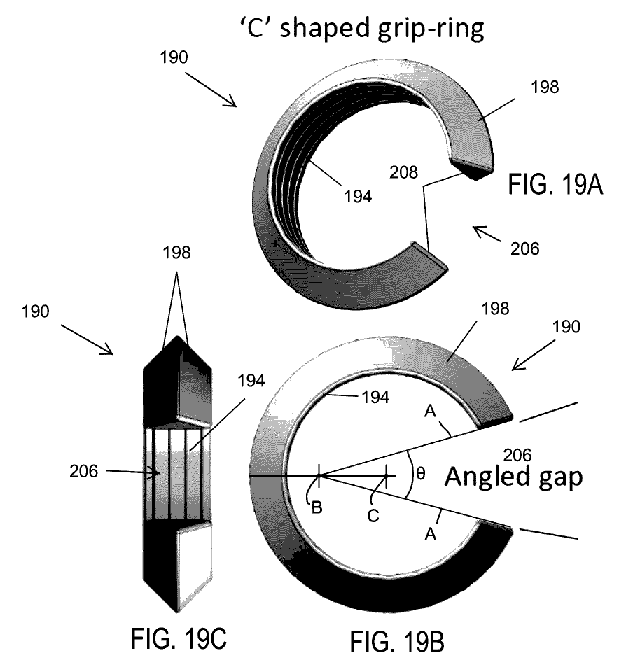

FIGS. 19A-19C illustrate an alternative construction of a gripping ring 190. The gripping ring 190 is similar to the gripping ring(s) 90 shown in FIGS. 1-8. Common components have the same reference number used with respect the gripping rings 90 plus 100. Description of the components above generally applies to the gripping ring 190, except for differences are described below.

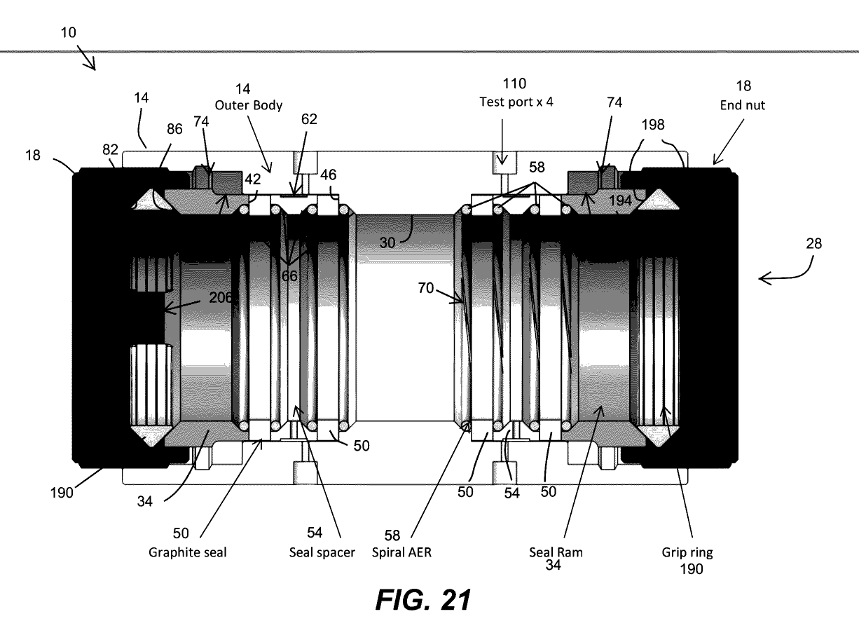

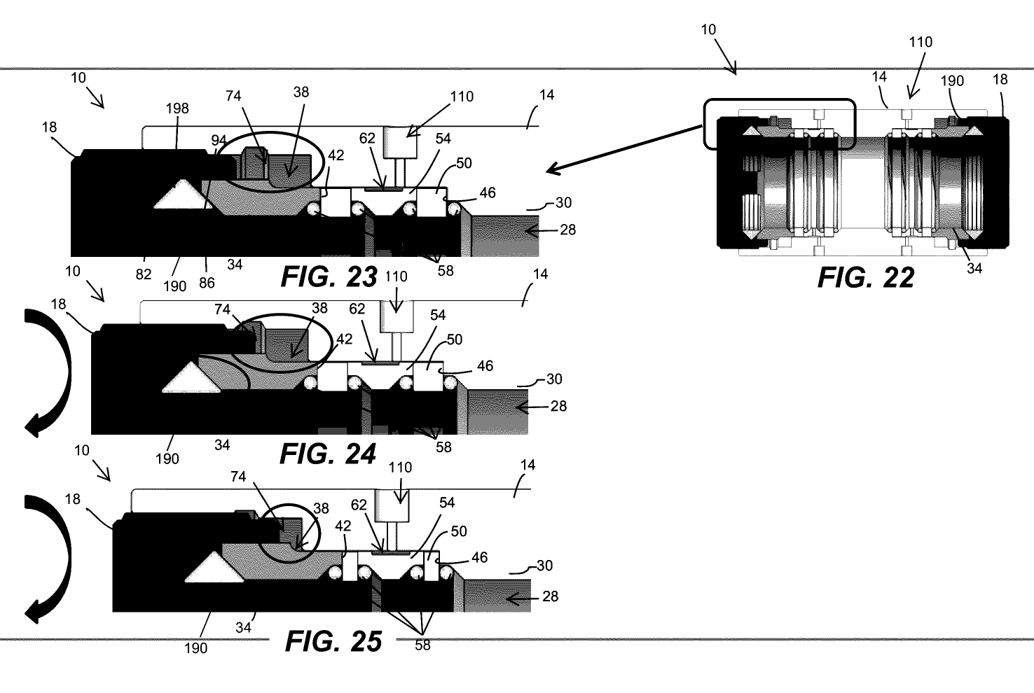

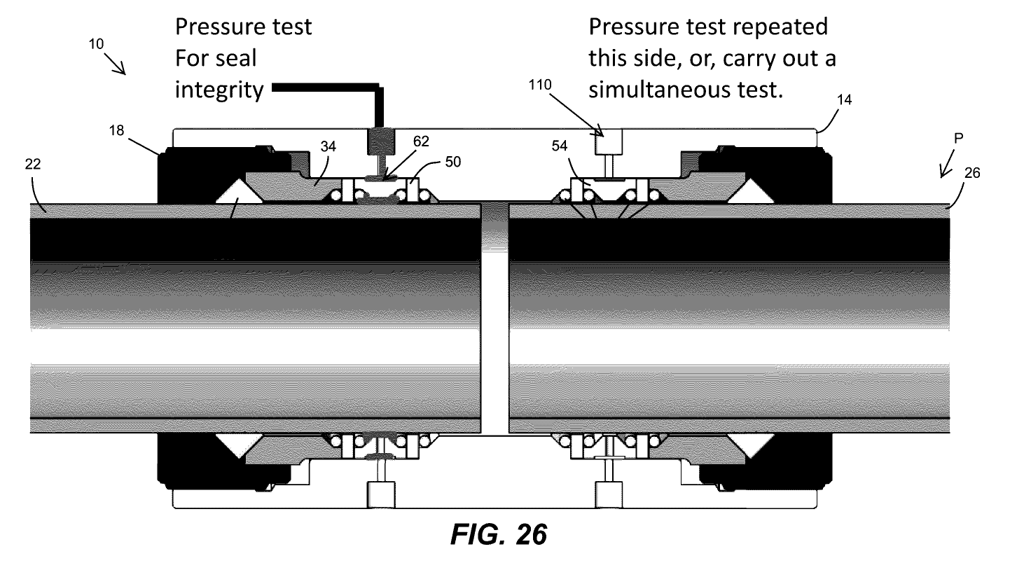

As shown in FIGS. 19A-19C, each gripping ring 190 is generally one-piece and has a generally triangular cross-section defined by a radial inner surface 194 and a pair of sloped surfaces 198. The cross-section of the gripping ring 190 is similar to the combined cross-section of two abutting gripping rings 90, as shown in FIGS. 1-8. In the illustrated construction, the sloped surfaces 198 are approximately equal length. The radial inner surface 194 of the gripping ring 190 may be profiled (i.e., formed with slits, grooves, bumps, etc.) to effect greater gripping capacity. Because the gripping ring 190 of FIGS. 19A-26 is essentially an integral single piece construction of the gripping rings 90 of FIGS. 1-8, the gripping ring 190 does not include the inner surface 102 of the gripping ring 90 of FIGS. 1-8.

The gripping ring 190 also has a pair of spaced apart ends 208 that define an angled cut gap 206 such that the gripping ring 190 has a generally “C” shape as shown in FIGS. 19A-19B, allowing the gripping ring 190 to contract (i.e., reduce in diameter) or expand (i.e., increase in diameter). In some embodiments, the gripping ring 190 may be able to expand and contract without plastically deforming. As shown in FIG. 19B, the illustrated ends 208 are flat surfaces between an inner radius and an outer radius, defining a pair of planes A that intersect along an intersect axis B that runs parallel to a central axis C of the gripping rings 190.

In the illustrated construction, the surfaces of the ends 208 and the planes A are oriented at the same angle relative to a radial plane intersecting each end 208. In other constructions (not shown), the surfaces of the ends 208 and the planes A may be oriented at different angles relative to the radial plane.

In the illustrated construction, the intersect axis B is radially offset from the central axis C by approximately half the outer radius of the gripping ring 190 and is generally opposite the gap 206. However, in other embodiments (not shown), the intersect axis B may be coaxial with the central axis C, or the intersect axis may be generally on the side of the central axis C closest to the gap 206. The intersect axis B may be located generally at any radial distance from the central axis C, either inside the gripping ring 190 or outside the gripping ring 190.

The planes A are spaced apart by an angle θ to define the gap 206. In the illustrated embodiment, the angle θ is between about 25 to about 35 degrees (e.g., approximately 30 degrees) for gripping rings of various diameters (e.g., a diameter of 4 inches). However, in other constructions (not shown), the angle θ may be approximately between about 25 to about 60 degrees for gripping rings of various diameters. For example, in some constructions, the angle θ is between about 27 to about 38 degrees (e.g., approximately 33 degrees) for gripping rings having a diameter of about 2 inches. In some other constructions, the angle θ is between about 50 to about 60 degrees (e.g., approximately 55 degrees) for gripping rings having a diameter of about approximately 1 inch.

As the gripping ring 190 is compressed during operation, the gripping ring 190 reduces in diameter to engage the pipe 22, 26. In the illustrated embodiment, when the gripping ring 190 is fully activated, the gripping ring 190 reduces in diameter such that the gap 206 has narrowed (e.g., to a width of 2 mm). In the illustrated embodiment, if the gripping ring 190 is fully compressed, the ends 208 of the gripping ring 190 contact one another preventing further reduction in diameter, thus preventing unintentional deformation to the pipe 22, 26. The gripping ring 190 may be constructed and/or the ends 208 may be angled such that the ends 208 meet together flush when the gripping ring 190 is fully compressed. Alternatively, the gripping ring 190 may be constructed and/or the ends 208 may be angled such that the ends 208 come into contact proximate the inner radius or the outer radius when the gripping ring 190 is fully compressed.

In other embodiments (not shown), the intersect axis B and, therefore, the planes A, may be angled relative to the central axis C resulting in a gap 206 similar to the scarf cut gap 106 of the gripping ring 90 shown in FIGS. 1-8. In yet further embodiments, the planes A may be parallel to each other.

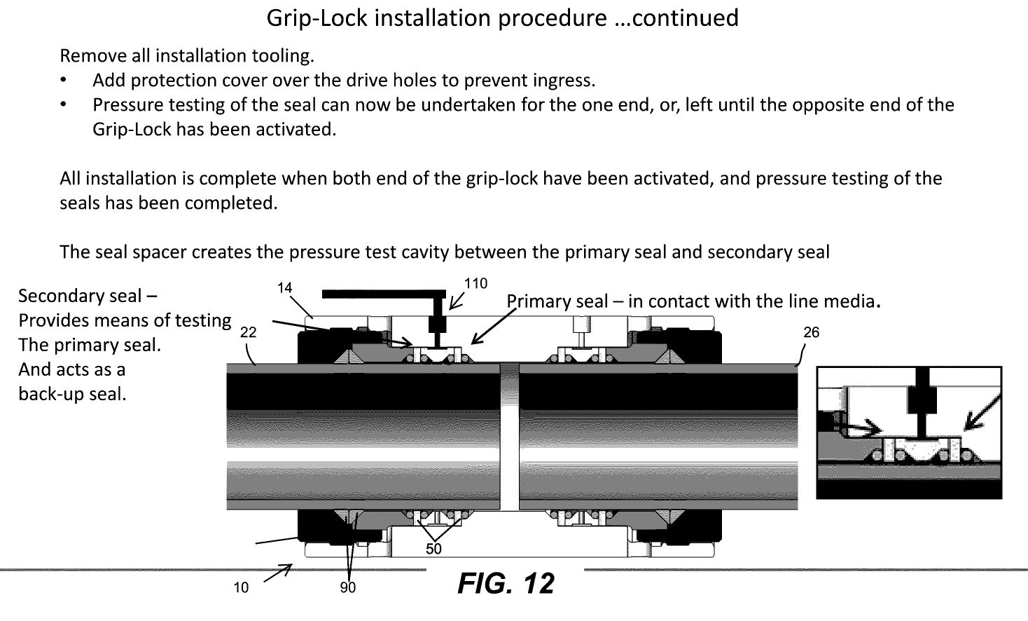

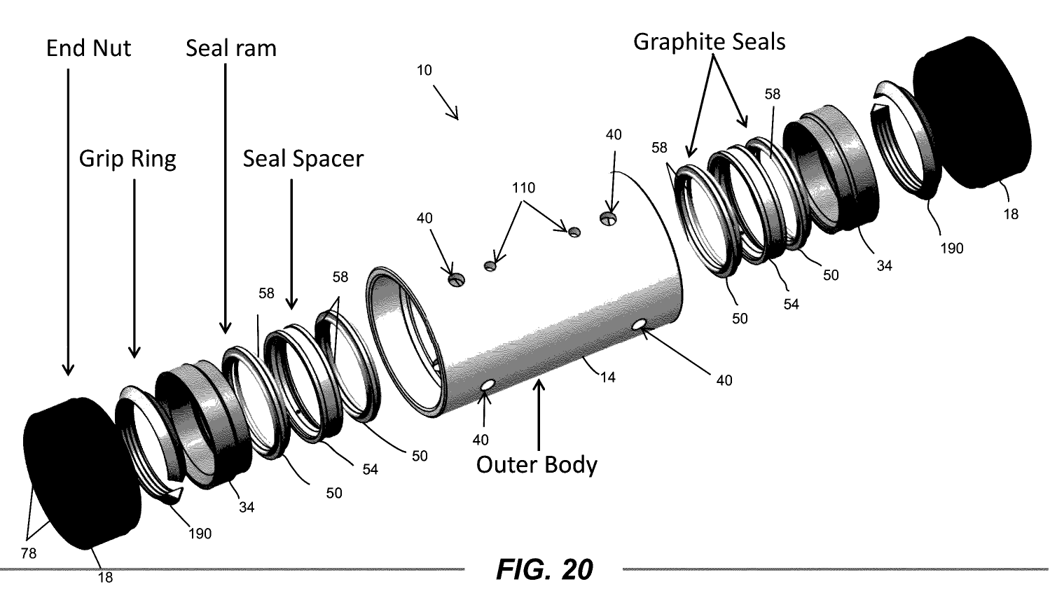

FIGS. 20-26 illustrate the connector 10 with the gripping ring 190 shown in FIGS. 19A-19C replacing the gripping rings 90 shown in FIGS. 1-8. Other than the gripping ring 190, other components of the connector 10 shown in FIGS. 20-26 are identical to those shown in FIGS. 1-12 and, accordingly, the description of like-numbered parts is the same as described above.

To direct the gripping ring 190 radially inwardly, the slanted engagement surfaces 82, 86 function as ramps in a similar fashion to the engagement surfaces 66. When each end nut 18 moves axially inwardly (i.e., toward the abutment 30), the engagement surfaces 82, 86 engage the sloped surfaces 198 of the gripping ring 190 to compress the ring 190. The ring 190 is forced radially inwardly to engage and conform to the outer surface of the associated pipe 22, 26, to hold the connector 10 in engagement with the pipes 22, 26, as discussed above.

The installation process will be described with respect to one end of the connector 10 (i.e., the end for pipe 22) for the construction with the grip rings 90 shown in FIGS. 1-8 and for the construction with the grip rings 190 shown in FIGS. 19-26. It should be understood that the illustrated installation process occurs in substantially the same manner for both ends of the connector 10. Further, some embodiments may include a center abutment that is slidable within the cavity defined by connector 10 and both ends of the connector 10 may be simultaneously activated to balance out movement of the center abutment and the graphite seals.

With reference to FIG. 10, after the ends of the pipes 22, 26 are slid into the connector 10, the split driving insert 138 is placed onto the outer diameter of the pipe 22 adjacent the end nut 18. The pins 150 of the split driving insert 138 are aligned with and inserted into the drive holes 78 of the end nut 18. Plastic transport dowels 140, provided in an assembled connector 10 to limit or prevent movement of internal components prior to installation, are removed from the outer body drive holes 40.

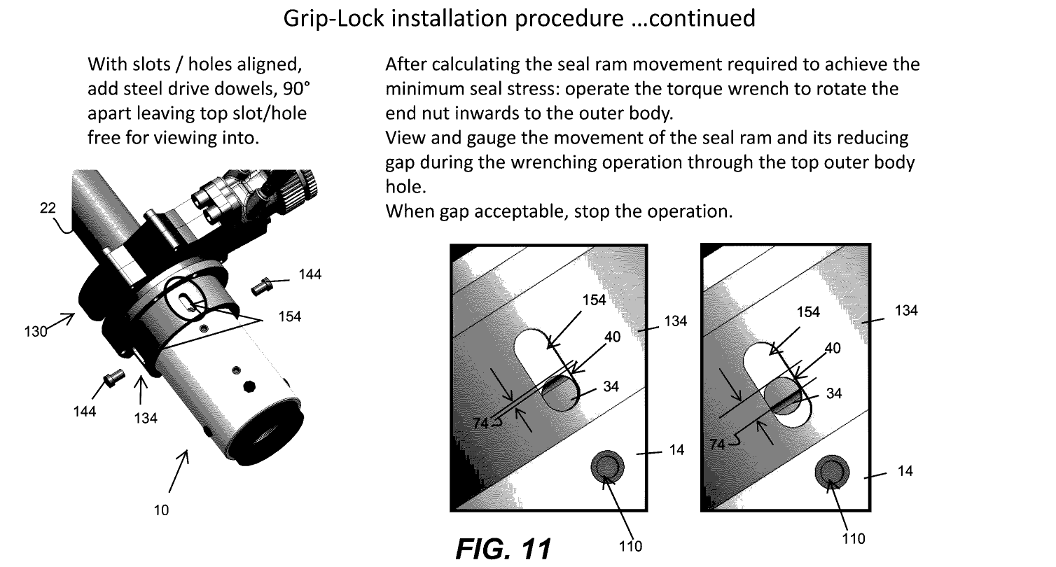

The torque wrench 130 and assembled pre-attached reaction sleeve 134 are placed over the pipe 22 and slid over the split driving insert 138. Slots 154 formed in the reaction sleeve 134 align with the outer body drive holes 40. With reference to FIG. 11, a pair of metal (e.g., steel) drive dowels 144 are inserted through the “side” slots 154 and holes 40, leaving the “top” and “bottom” slots 154 and drive holes 40 free for viewing.

After calculating the movement of the seal ram 34 desired or required to achieve the minimum seal stress needed for a desired application, the user operates the torque wrench 130 to rotate the end nuts 18 inwardly with respect to the body 14. The user views the “top” or “bottom” slot 154 and drive holes 40 to gauge the movement of the seal ram 34, as it reduces the gap 74 (FIG. 11). When the gap 74 is the desired size, the gripping rings 90, 190 grip the pipe 22, and the seals 50 form a seal between the pipe 22 and the components of the connector 10.

At this point, operation of the torque wrench 130 is halted, and the remaining installation equipment is removed (i.e., reaction sleeve 134, split driving insert 138, etc.). Protective covers (not shown) are inserted into the outer body drive holes 40 to prevent ingress of unwanted materials, contaminants, etc. To confirm that the connector 10 has been installed correctly, the pressure test port 110 is accessed to permit external pressure testing for seal verification prior to placing the pipeline P into service.

During the installation process, the gripping rings 90, 190 are first activated (i.e., directed radially inwardly to engage the outside surface of the associated pipe 22, 26) by each end nut 18 meeting the associated seal ram 34 with opposition. By moving the end nut 18 axially inwardly, the seal ram 34 is, in turn, also moved axially inwardly (i.e., toward the abutment 30), compressing the seal(s) 50 radially onto the pipe surface. In meeting this resistance, the gripping rings 90, 190 engage the slanted surfaces 82, 86 (FIG. 5) and are forced radially inwardly into contact with the associated pipe 22, 26 (FIGS. 7-8, and 25-26).

Inward movement of the each end nut 18 continues, overcoming the opposition of the seal ram 34. The seal ram 34, in turn, also continues to move inwardly, continuing to compress the seal(s) 50 forming an ever more densely packed volume to affect the pressure tight seal. Further axial movement (e.g., by turning of the torque wrench 130) causes the anti-extrusion ring(s) 58 to close down onto the outer surface of the associated pipe 22, 26, in a manner similar to the gripping rings 90, 190 by action of the flowing nature of the seals 50 while being compressed. Continued axially inward movement of the end nut 18 increases the radial contact load of the gripping rings 90, 190 onto the outer surfaces of the associated pipe 22, 26.

In some embodiments, the connector 10 may be removable from one application (e.g., a first pipeline P) and re-installed or installed onto another application (e.g., another pipeline (not shown)) by simply replacing the seals 50 and re-using the gripping rings 90, 190. To remove the connector 10, the installation process is generally reversed.

The manner of operation of the construction of the connector 10 shown in FIGS. 20-26 with the gripping rings 190 of FIGS. 19A-19C is essentially the same as that described above in connection with the connector 10 configured with the gripping rings 90 shown in FIGS. 1-8.

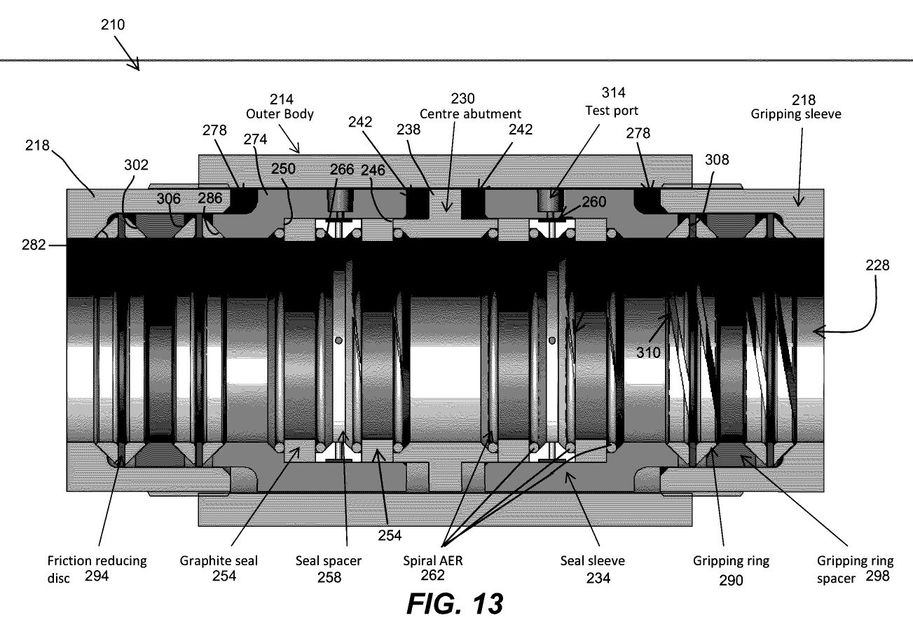

FIGS. 13-18 illustrate a grip-lock pipeline connector 210 in accordance with an alternative embodiment of the invention. The connector 210 is similar to the connector 10 described above and illustrated in FIGS. 1-12. The illustrated connector 210 is substantially symmetric about a center vertical axis, with respect to FIG. 13, and any feature or element referenced on one side of the connector 210 equally pertains to the mirrored feature or elements on the other side of the connector 210. As an example, the connector 210 may be for above ground use on pipelines P in the range of 1 inch to 4 inches and having a pressure rating of about class 150 (i.e., 31 bar).

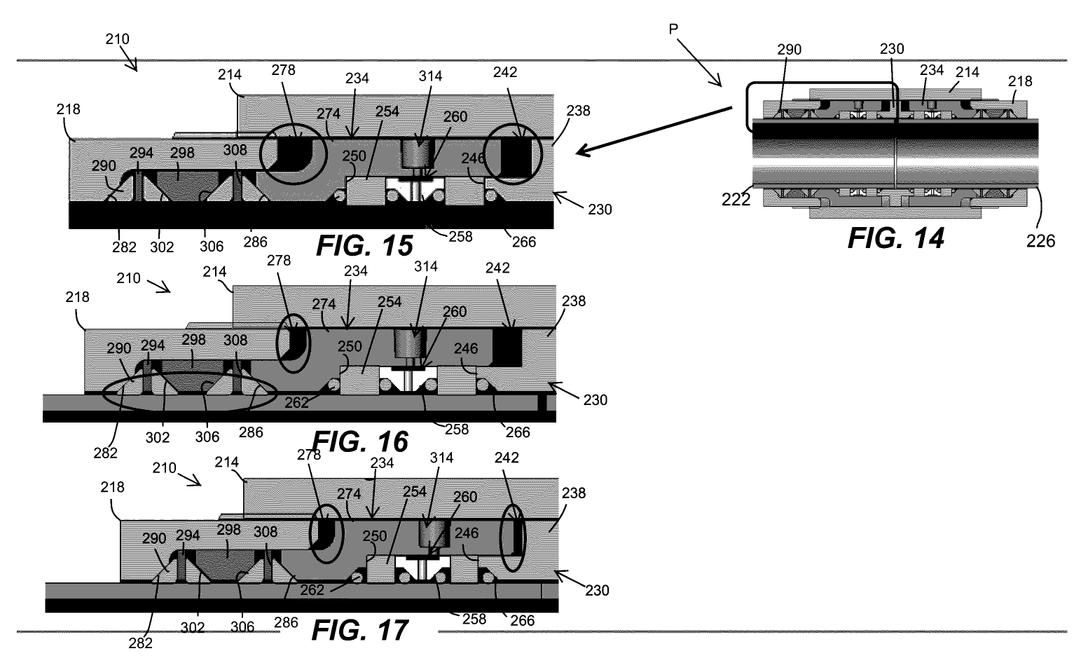

The connector 210 includes an outer body 214 and a pair of gripping sleeves 218 that move axially (i.e., along the longitudinal axis of the connector 210) inwardly and outwardly with respect to the body 214 for compressing various components held within a cavity defined by the body 214. The connector 210 is configured to grip onto and fluidly connect a first pipe 222 and a second pipe 226 (FIG. 14) of a pipeline P. Each of the gripping sleeves 218 and other components of the connector 210 define a cylindrical opening or bore 228 for receiving the end portions of the pipes 222, 226.

The connector 210 includes a center abutment 230 received within the cavity of body 214 and formed as a separate piece therefrom. The abutment 230 is located near the middle of the cavity with a seal sleeve 234 on each side. The abutment 230 has a rib 238 extending radially outward from the body of the abutment 230 with a width less than the width of the body of the abutment 230. Gaps 242 are defined between opposite portions of the abutment 230 and the seal sleeves 234. The seal sleeves 234 are movable inwardly with respect to the body 214 (i.e., toward the abutment 230) to reduce the size of the gaps 242.

While referred to as a “center abutment”, the abutment 230 does not necessarily provide a reaction surface against which one of the pipes 222, 226 engages. The center abutment 230 generally guides and centralizes the pipes 222, 226 and has a width to accommodate an open tolerance for pipe insertion. For example, FIG. 14 illustrates that the ends of the pipes 222, 226 do not need to engage a reaction surface of the abutment 230, or each other, but can be provided in a spaced relationship within a region defined by the center abutment 230.

The abutment 230 and the seal sleeves 234 each include an engagement surface 246, 250, respectively, to compress, therebetween a number of seals (e.g., two seals 254) when the sleeves 234 are moved axially inwardly. The seals 254 are axially spaced apart by seal spacers 258 and scarfed, wire-type, anti-extrusion rings 262 (AERs). A void 260 is defined axially between the seals 254 (e.g., in the seal spacer 258) on each side of the abutment 230.

When the sleeves 234 move axially inwardly (i.e., toward the abutment 230), the material of the seals 254 compresses and is forced radially inwardly to engage the outer surface of the associated pipe 222, 226, to form a pressure tight seal. When compressed axially, the seal 254 extrudes radially inwardly and outwardly to provide a seal between the exterior surface of the associated pipe 222, 226 and a component of the connector 210 (e.g., the inner surface of the seal sleeve 234 in the illustrated construction).

The illustrated seals 254 are of the type used in the commercially available line of engineered mechanical subsea connectors manufactured by Hydratight Limited, as described above. The seal 254 may be graphite seals formed of, for example, 98% pure exfoliated graphite. The seal 254 may include a laminate graphite sheet and/or be ribbon spun or spiral-wound around a mandrel into a mold that can be subsequently manipulated into a suitable construction (e.g., size, shape, etc.) for the connector 210. In other constructions, the seal 254 may include any of a variety of other seal packing materials.

In the illustrated construction, the seals 254 are prevented from extruding into gaps between the pipes 222, 226 and adjacent components of the connector 210 by the anti-extrusion rings 262, which can close down onto (i.e., move radially inwardly with respect to) the pipes 222, 226. Specifically, components (e.g., the abutment 230, the seal spacers 258, and the seal sleeves 234) adjacent the rings 262 include slanted engagement surfaces 266, which function as ramps to direct the rings 262 radially inwardly.

As the seals 254 and, more specifically, the top portion of the seals 254, are compressed, the bottom portions of the seals 254 expand. This forces the rings 262 into further engagement with the slanted surfaces 266, which directs the rings 262 radially inwardly. The rings 262 include a spiral or scarf cut 270 such that they are able to contract (i.e., decrease in diameter) or expand (i.e., increase in diameter) without plastically deforming.

The seal sleeves 234 are at least partially received by an opening defined by gripping sleeves 218. The seal sleeves 234 also include an outer portion 274 extending radially outwardly from the body of the seal sleeves 234. Gaps 278 are defined between portions of the gripping sleeves 218 and the seal sleeves 234. The gaps 278 allow the gripping sleeves 218 to move inwardly with respect to body 214 (i.e., toward the seal sleeves 234 and the abutment 230) to reduce the size of the gaps 278. To facilitate this inward movement, the gripping sleeves 218 may include a threaded region engaging a complementary threaded region of the body 214. The illustrated gripping sleeves 218 may be moved axially inwardly by means of turning or rotating the gripping sleeves 218 in a controlled manner.

The gripping sleeves 218 and the seal sleeves 234 include slanted engagement surfaces 282, 286, respectively. When the gripping sleeves 218 are moved axially inwardly, the engagement surfaces 282, 286 compress therebetween a number of gripping rings (e.g., four gripping rings 290 in the illustrated construction), at least some of which are located at least partially within the opening defined by the associated gripping sleeve 218.

In the illustrated construction, the gripping rings 290 are axially spaced apart by friction reducing washers or discs 294 and gripping ring spacers 298 to prevent adverse interaction when in contact with the pipes 222, 226. The discs 294 reduce contact friction of the gripping rings 290 when the gripping rings 290 contract or expand. The discs 294 may be coated with a dry film lubricant to assist in further reducing contact friction. In addition to the slanted engagement surfaces 282, 286, the gripping ring spacers 298 also include slanted surfaces 302, which function as ramps to direct the gripping rings 290 radially inwardly.

It should be understood that, in an alternate construction of the grip-lock pipeline connector 210 shown in FIGS. 13-18, the gripping rings 290 and the corresponding friction reducing disc 294 positioned between the gripping rings 290 may be replaced with the gripping ring 190 shown in FIGS. 19A-19C. Description of the operation of the grip-lock pipeline connector 210 with respect to FIGS. 13-18 should be understood to be essentially equivalent when the gripping ring 190 is used instead of the gripping rings 290 and friction disc 294.

Each illustrated gripping ring 290 has a generally triangular cross-section with a sloped surface 306 engaged by the slanted surfaces 282, 286, 302 to direct the gripping rings 290 radially inwardly and a surface 308 extending transverse to the longitudinal axis and engaged by one of the friction reducing discs 294. The gripping rings 290 include a spiral or scarf cut 310 such that they are able to contract (i.e., reduce in diameter) or expand (i.e., increase in diameter) without plastically deforming as they are directed radially inwardly or outwardly, respectively.

When the sleeves 218 move axially inwardly (i.e., toward the abutment 230), the rings 290 compress and are forced radially inwardly to engage and conform to the outer surface of the pipes 222, 226, to hold the connector 210 in engagement with the pipes 222, 226. The radial inner surface of the gripping rings 290 may be profiled (i.e., formed with slits, grooves, bumps, etc.) to effect greater gripping capacity.

To direct the gripping rings 290 radially inwardly, the slanted engagement surfaces 282, 286, 302 function as ramps. When the gripping sleeves 218 move axially inwardly (i.e., toward the abutment 230), the engagement surfaces 282, 286, 302 engage the sloped surfaces 306 of the gripping rings 290 to compress the rings 290. The rings 290 are forced radially inwardly to engage and conform to the outer surface of the associated pipe 222, 226, to hold the connector 210 in engagement with the pipes 222, 226.

With respect to FIGS. 13 and 18, the connector 210 also includes at least one threaded pressure test port 314. To confirm that the connector 210 has been installed correctly, the void 260 between each seal 254, at each end of the connector 210, can be accessed by the pressure test port 314 and pressurized to a desired hydraulic pressure. The hydraulic pressure is held for an appropriate length of time to confirm the seal integrity and gripping capacity of the connector 210 as a whole.

In FIG. 13, the connector 210 is illustrated in a condition for assembly with a pipeline P. To assemble, the ends of the pipes 222, 226 are slid into the bore 228 of the connector 210 (FIG. 14). When the pipes 222, 226 are inserted into the bore 228, the gaps 242, 278 are at their maximum separation distance (FIG. 15) with of the components of the connector 210 (e.g., gripping rings 290, anti-extrusion rings 262, etc.) directed radially inwardly (i.e., into the bore 228) and the bore 228 fully opened to receive the pipes 222, 226 without causing damage to either the pipes 222, 226 or the connector 210.

The connector 210 is then activated by a hand-held external activation system to grip onto the pipe by the internal gripping rings 290. The hand-held external activation system used to activated the connector 210 may be similar to the activation system 126 described above. With the separate center abutment 230, each end of the connector 210 is activated simultaneously to balance relative movement of the components of the opposite ends.

During the installation process, the gripping rings 290 are first activated (i.e., directed radially inwardly to engage the outside surface of the associated pipe 222, 226) by moving the gripping sleeves 218 axially inwardly toward the abutment 230 by means of pushing or turning by threaded contact such that the gripping sleeves 218 are met with opposition from the seal sleeves 234. By moving the gripping sleeves 218 axially inwardly, the seal sleeves 234 are, in turn, also moved axially inwardly (i.e., toward the abutment 230), compressing the seals 254 radially onto the pipe surface. In meeting this resistance, the gripping rings 290 engage the slanted surfaces 282, 286, 302 and are forced radially inwardly into contact with the associated pipe 222, 226 (FIG. 16).

Inward movement of the gripping sleeves 218 continues, overcoming the opposition of the seal sleeves 234. The seal sleeves 234, in turn, also continue to move inwardly, continuing to compress the seals 254 forming an ever more densely packed volume to affect the pressure tight seal. Further axial movement (e.g., by turning) causes the anti-extrusion rings 262 to close down onto the outer surface of the pipes 222, 226, in a manner similar to the gripping rings 290, by action of the flowing nature of the seals 254 while being compressed (FIG. 17). Continued axially inward movement of the gripping sleeves 218 increases the radial contact load of the gripping rings 290 onto the outer surfaces of the associated pipe 222, 226.

The axial inward movement of the gripping sleeves 218 is stopped once the gripping sleeves 218 have moved inwardly by a pre-determined distance (FIG. 17), or when the gripping sleeves 218 have been tightened to reach a pre-determined level of torque (i.e., if moved inward by threaded contact with the body 214). To confirm that the connector 210 has been installed correctly, the pressure test port 314 is accessed to permit external pressure testing for seal verification prior to placing the pipeline into service.

The connector 210 is removable from one application (e.g., a first pipeline P) and re-installed or installed onto another application (e.g., another pipeline (not shown)) by simply replacing the seals 254 and re-using the gripping rings 290. To remove the connector 210, the installation process is generally reversed.

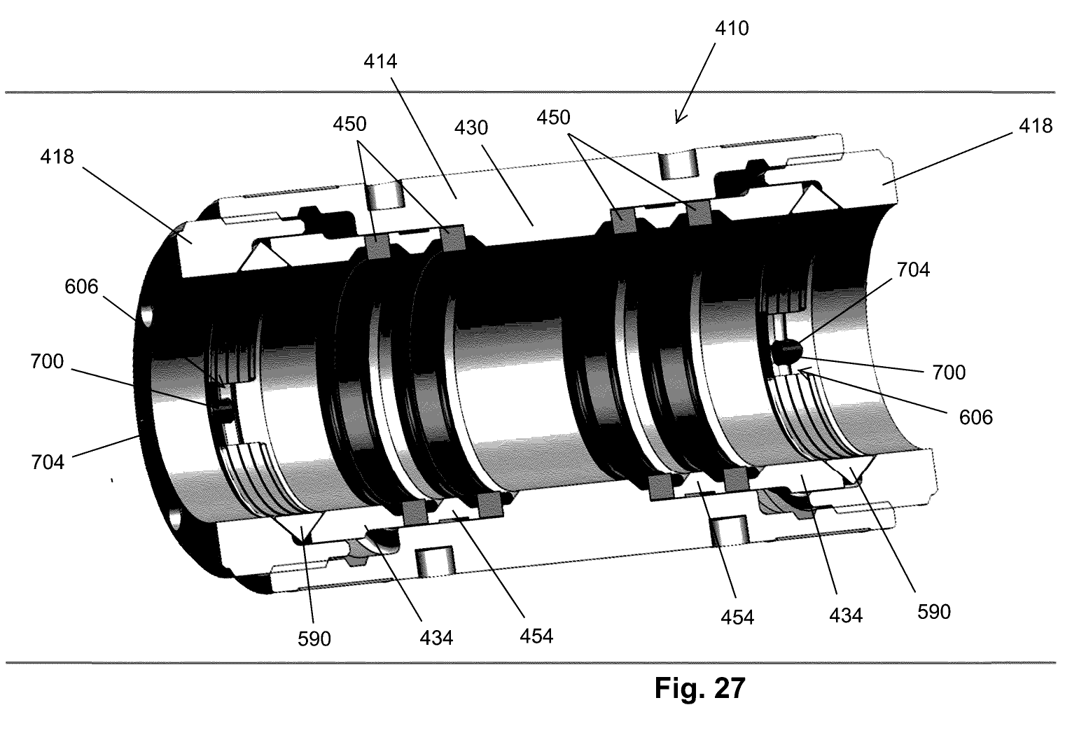

FIGS. 27-32B illustrate a grip-lock pipeline connector 410 in accordance with another alternative embodiment of the invention. The connector 410 is similar to the connector 10 and 210 described above and illustrated in FIGS. 1-26. The illustrated connector 410 is substantially symmetric about a center vertical axis, with respect to FIG. 27, and any feature or element referenced on one side of the connector 410 equally pertains to the mirrored feature or elements on the other side of the connector 410. Common components of the connector 410 have the same reference number as the connector 10 plus “400”.

In some installation operations, when the first end is activated by turning the first end nut to simultaneously activate the first seal(s) and the first gripping ring(s), the first gripping ring closes down onto the associated first pipe and pulls the pipe along until the seal has compressed at a predetermined distance or torque. When the second pipe is abutted with the first, when the second end is activated in the same manner by turning the second end nut to simultaneously activate the second seal(s) and the second gripping ring(s), the second gripping ring closes down onto and tries to pull the second pipe but cannot due to the abutment with the first pipe and the opposing resistance.

The torque to overcome the friction between the second gripping ring and the second pipe to move to compress the second seal(s) is excessive and greatly exceeds the torque required on the first end. A pipe connector generally cannot be operated with different torque values on the opposite ends. This situation may be alleviated by not abutting the pipes before activation of the second end, but this relative positioning of the pipes cannot be guaranteed.

The connector 410 generally includes an arrangement to separate or decouple activation of the seal(s) 450 from activation of the gripping ring(s) 590. In the illustrated construction, the arrangement includes one or more dowel pins 700 engageable in the gap 606 of the gripping ring 590 to limit radial compression of the gripping ring 590 and engagement with the pipe (not shown). In this construction, the seal(s) 450 are activated, and movement of the pin(s) 500 out of the gap 606 allows for final activation of the gripping ring(s) 590 to engage and grip the pipe. The arrangement keeps the gripping ring 590 clear of the pipe until seal activation to prevent the pipe from being dragged along for the operation. Such an arrangement may not be necessary when there is no gripping feature in the pipe connector.

The end nut 418 defines an opening 704 to receive each pin 700 (one in the illustrated construction). In other constructions (not shown), the end nut 418 may define a number of openings 704 to allow the pin 700 to be supported in a number of different circumferential positions on the end nut 418 to be received into the gap 606.

The pin 700 and the opening 704 include cooperating structure (e.g., threads) to adjustably position the pin 700 on the end nut 418. The pin 700 is arranged to selectively extend into the gap 606 in the gripping ring 590 and to be moved out of the gap 606. In the illustrated construction, the pin 700 is removed from the end nut 418 when it is not needed in the gap 606.

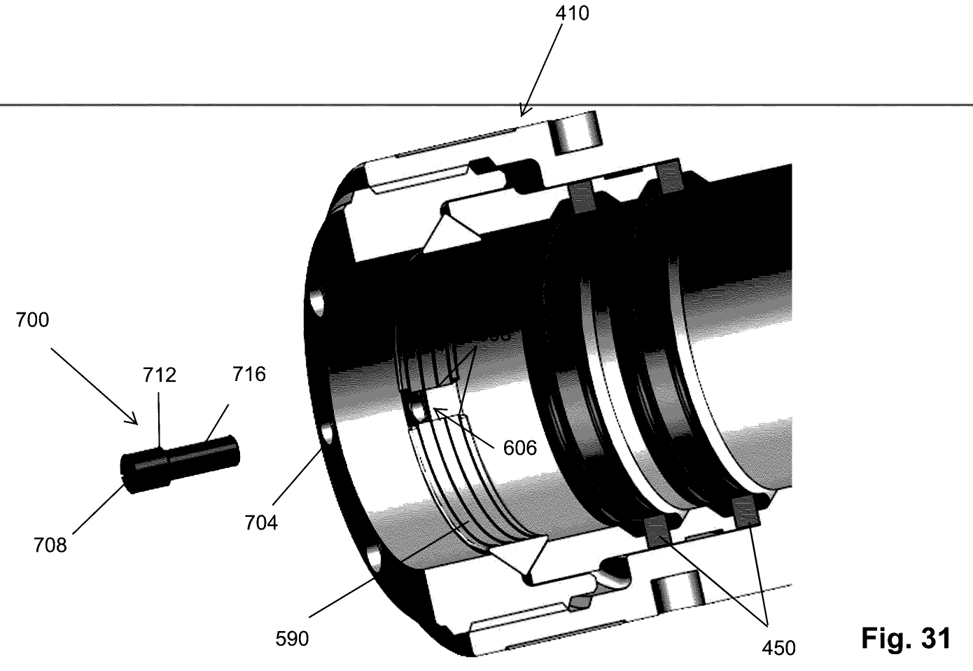

The pin 700 has (see FIG. 31) a head 708 engageable by a tool (not shown; e.g., a screwdriver) to be adjusted relative to the end nut 418. A shoulder 712 on the pin 700 limits axial inward movement of the pin 700 on the end nut 418. The pin 700 has an engagement surface 716 for engagement with the gripping ring 590. In the illustrated construction, only a portion of the pin 700 (e.g., between the shoulder 712 and the head 708) is threaded, and the engagement surface 716 is relatively smooth. In the illustrated construction (see also FIG. 19), the ends 608 of the gripping ring 590 are generally flat and engage the engagement surface 716. The flat configuration of the ends 608 may reduce the cost of manufacture of the gripping ring 590.

In another construction (see FIG. 33), each end 608 of the gripping ring 590 includes a profiled (e.g., curved) portion 720 to engage the engagement surface 716 of the pin 700 before the gripping ring 590 is activated and grips the pipe. Each end 608 also includes a contact portion 724 engageable when the pin 700 is removed to limit further reduction in diameter/radial compression of the gripping ring 590, thus preventing unintentional deformation to the pipe. The contact portion 724 has a length less than the radius of the pin 700 to ensure that the profiled portions 720 engage the pin 700 with the contact portions 724 being maintained out of engagement.

FIG. 35 illustrates an alternative construction of the dowel pin arrangement. In this construction, two pins 700 (and at least two corresponding openings 704 in the end nut 418) are provided. Each pin 700 is engageable with one end 608 of the gripping ring 590 to restrict activation of the gripping ring 590. In the illustrated construction, each end 608 has a profiled portion 720 to engage the engagement surface 716 of the associated pin 700, and each profiled portion 720 extends around a portion of the circumference of the pin 700 on opposite sides of the pin axis. The illustrated multi-pin arrangement may be provided for a relatively large gripping ring gap 606 to prevent closure of gripping ring 590 onto the pipe.

The pin arrangement may be applied to a scarf-cut gripping ring (such as the gripping ring 90, described above). In such constructions (not shown), a pin (such as the pin 700) is positioned to limit radial movement of the scarf-cut gripping ring to grip the pipe P. The scarf cut of the gripping ring is in a different plane to the pin 700 described above. In one example, if the end nut is constructed (e.g., made longer) so that the gripping ring is outside of and does not enter the outer body (while being adjacent the activation face of the end nut), the pin can be radially inserted and removed, applying a similar arrangement to the C-shape gripping ring 590.

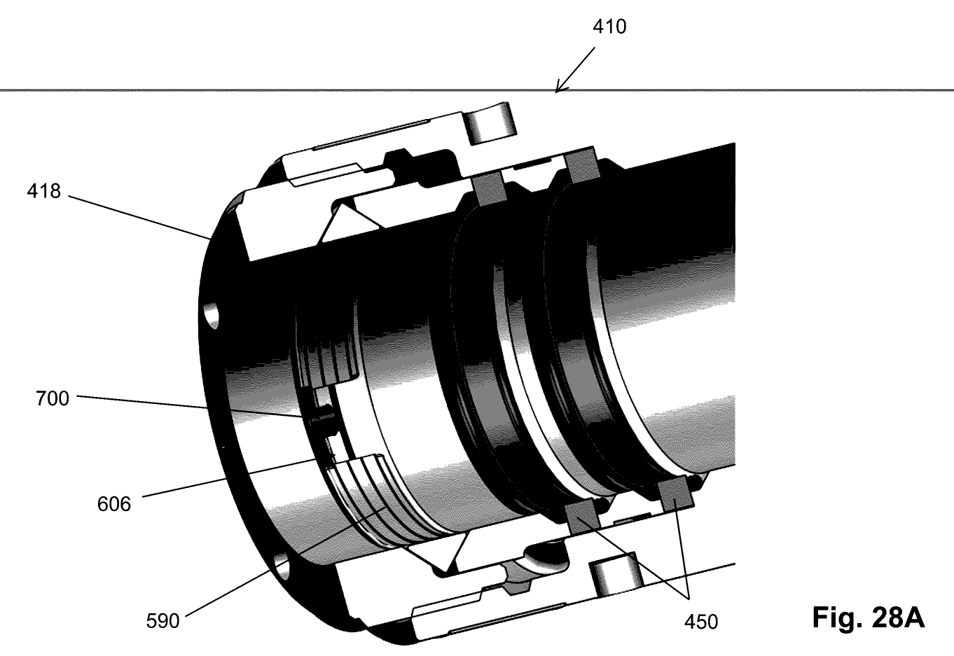

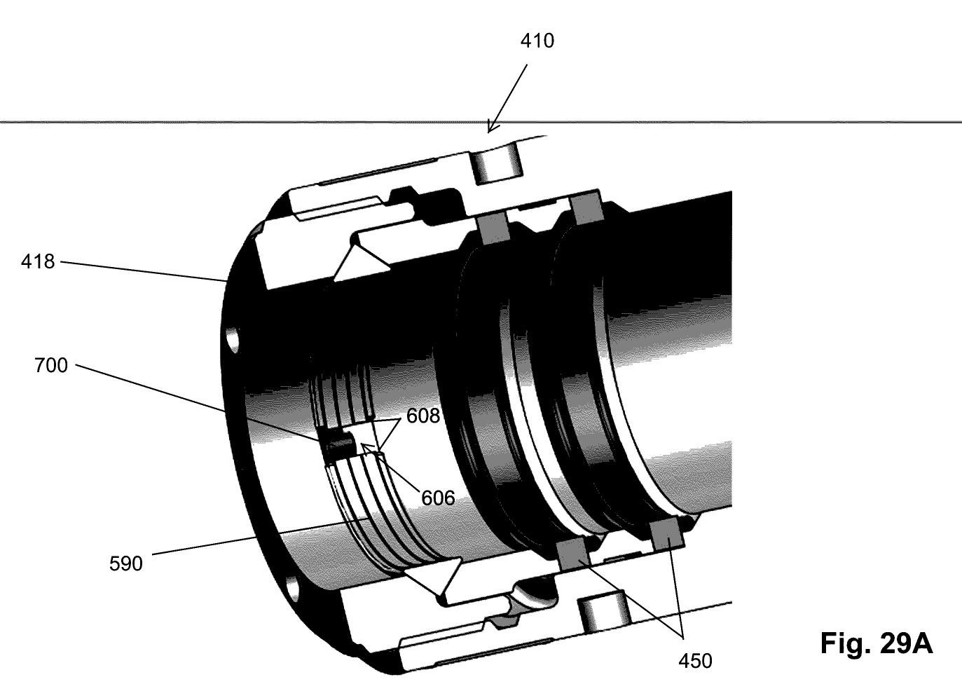

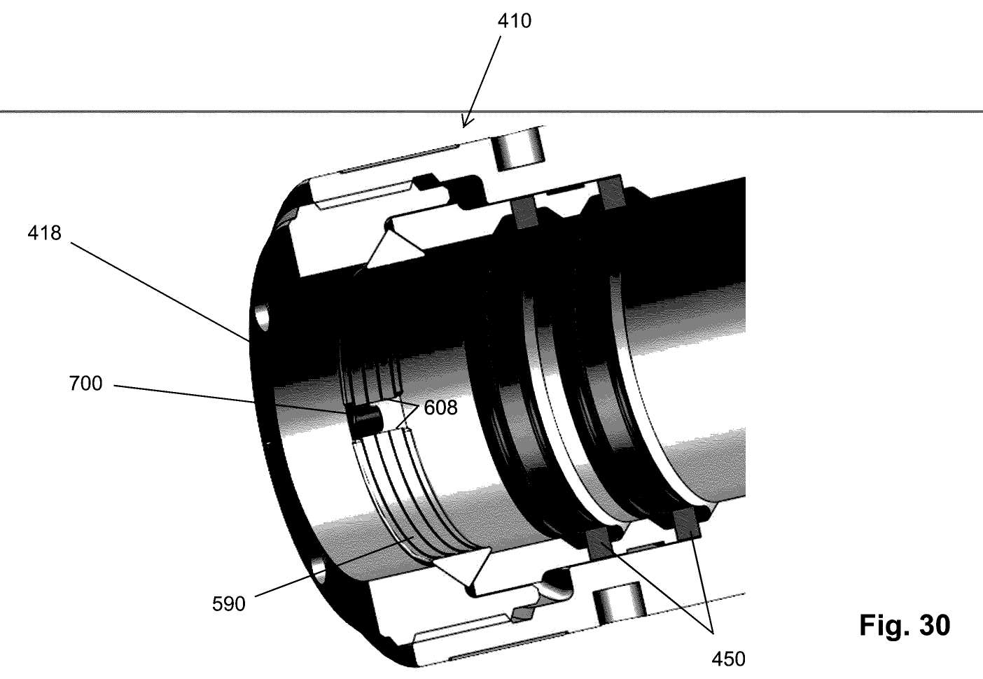

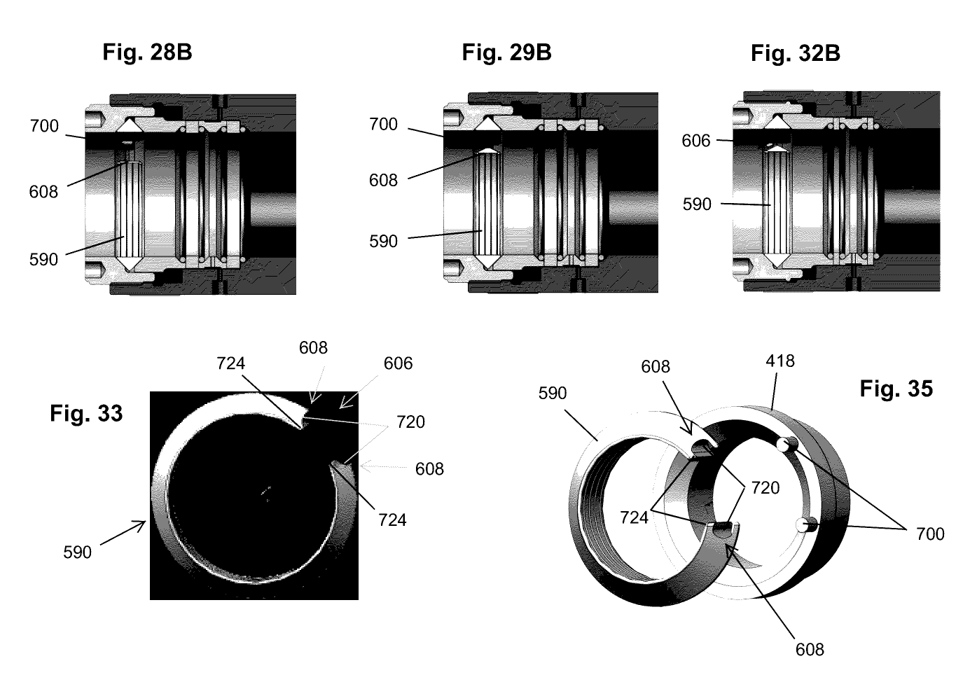

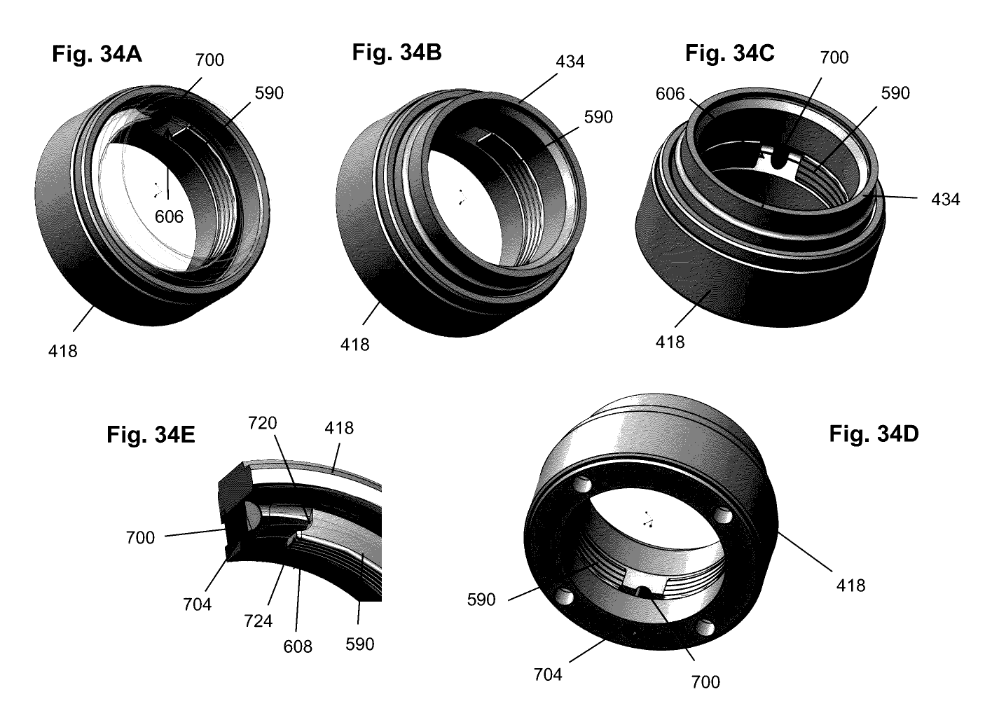

FIGS. 28A-32B illustrate installation of the pipe connector 410. As shown in FIGS. 28A-28B (and in FIGS. 34A-34E), the pipe connector 410 is assembled and ready for installation. As shown in FIGS. 29A-29B, the end nut 418 is initially turned or torqued. The end nut 418 rotates and advances, and the seal(s) 450 compress slightly (e.g., to about 1 tonne-force). During this period, the gripping ring 590 closes down onto the pin 700 and cannot radially compress any further to engage and grip the pipe. Thereafter, as shown in FIG. 30, the end nut 418 continues to rotate and advance, and the seal(s) 450 continue to compress.

Due to Graphite-to-steel friction being lower than steel-to-steel friction, the ram 434 rotates, ensuring that the pin 700 is not used as a drive pin. The pin 700 is only under compression, as are the ends 608 of the gripping ring 590. Because the pin 700 is not subjected to torque, the end nut 418 is less likely to be damaged and can remain as a slender design.

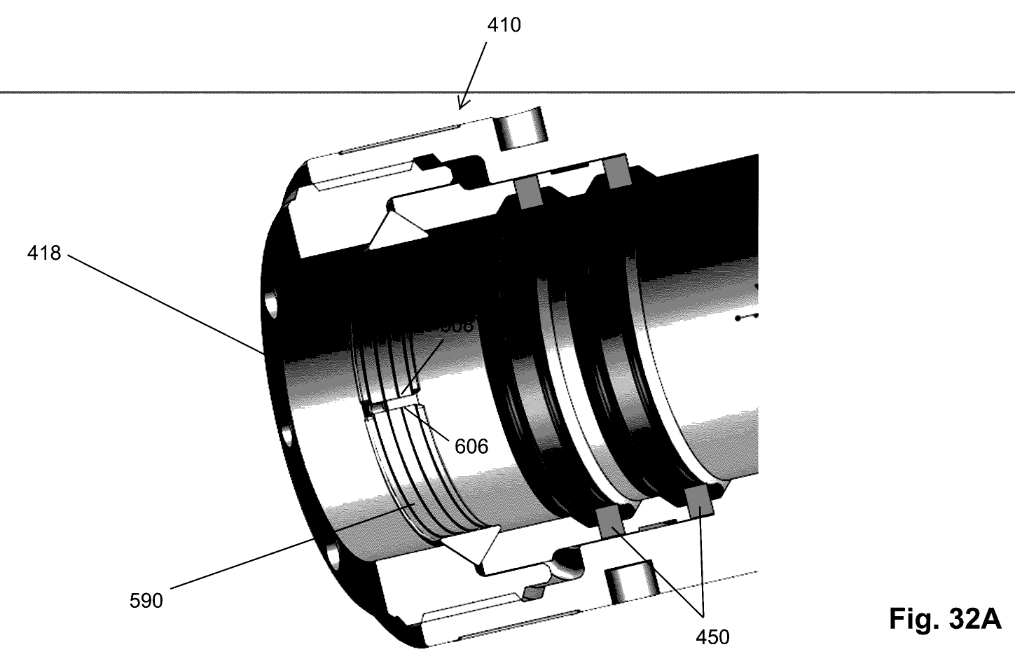

With the seal(s) 450 at the correct compression (see FIG. 31), the pin 700 is removed. As shown in FIGS. 32A-32B, the end nut 418 is continued to be turned to previously-described torque level (e.g., once the end nut 418 has moved inwardly by a pre-determined distance or have been tightened to reach a pre-determined level of torque) to activate the gripping ring(s) 590 to engage and grip the pipe while maintaining compression of the seal(s) 450. The operation then ends.

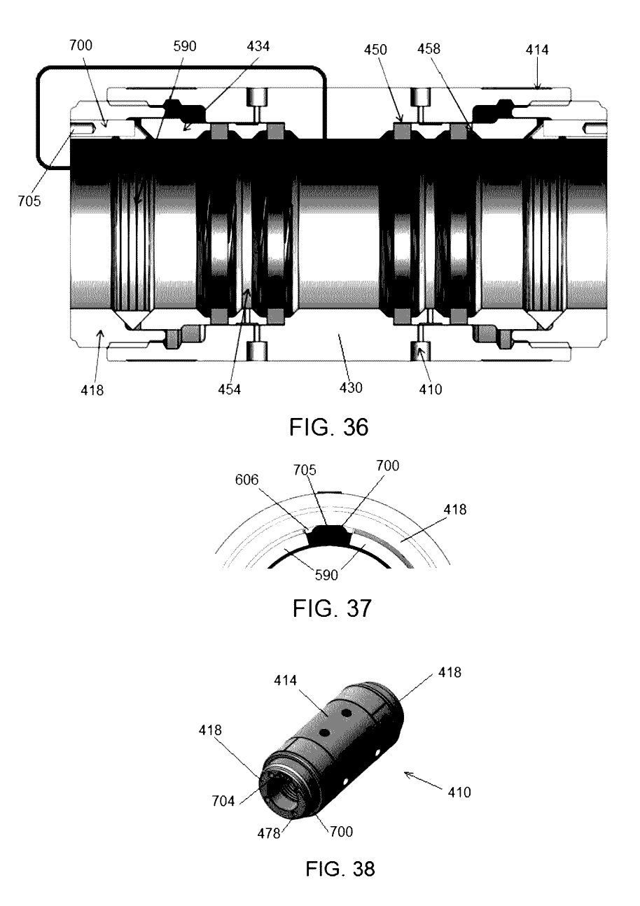

The above illustrated embodiments in FIGS. 27-35 work particular well in class 150 series pressure ratings. However, when moving to class 300 pressure ratings, modified pins 700 may be necessary to avoid premature compression of the gripping ring 590. FIGS. 36-41 illustrate several other embodiments of the pin 700.

FIGS. 36-39D illustrate a grip-lock pipeline connector 410 including a dowel pin 700 having alternative configuration compared to the previous embodiments. In particular, the dowel pin is dimensioned and configured to fill substantially the entire opening or gap 606 of the grip ring 590 to keep the grip ring from compressing or closing down on to the pipe (not shown) until the dowel pin 700 is removed. This allows the internal parts to move axially to create a seal on both sides of the abutment 430 without requiring different torque figures on each end of the pipeline connector. In this construction, the seal(s) 450 are activated, and movement of the pin(s) 700 out of the gap 606 allows for final activation of the gripping ring(s) 590 to engage and grip the pipe. The arrangement keeps the gripping ring 590 clear of the pipe until seal activation to prevent the pipe from being dragged along for the operation.

The embodiments of the dowel pin(s) 700 shown in FIGS. 36-41 all have the following common features. First, they substantially fill the entire gap 606 (circumferentially measured) prior to activation or force applied to the grip ring 590. As such, the grip ring 590 substantially keeps its shape until the pin(s) 700 are removed. Second, the pin(s) 700 are shaped to minimize points of contact with the grip ring 590. In particular, the illustrated pins 700 include rounded edges (opposed to flat ends) to engage the grip ring 590. This helps reduce the force required to remove the pin from the gap. Some embodiments of the pin 700 may utilize other shapes, such as a pure rectangular shape or trapezoidal shape if reduced removal force in not desired.

As seen in FIGS. 36-39D, the preferred shape of the pin 700 of this embodiment is a stadium prism. In particular, as seen in FIGS. 37 and 38, the pin 700 has a stadium or pill shaped end that extends in the axial direction of the connector 410. For the purposes of this invention, a stadium is a two-dimensional geometric shape constructed of a rectangle with semicircles (or portions thereof) at a pair of opposite sides. This configuration has been found to provide optimal gap 606 filling (circumferentially) while allowing for minimal contact or frictional engagement with the grip ring 590 to allow relatively easy removal of the pin 700 when desired.

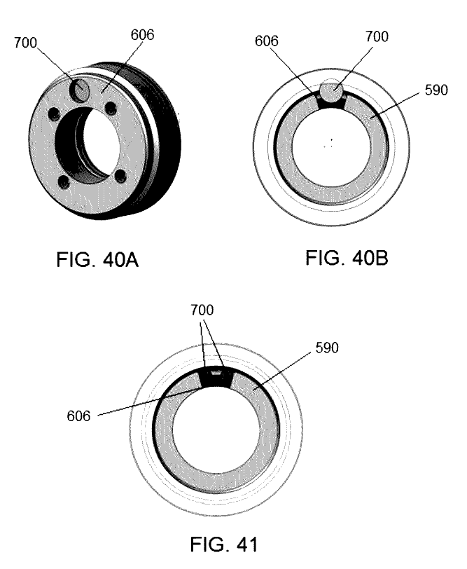

Other oblong configurations would work as well, such as an elliptical prism or oval prism. Also, a diamond or kite shaped prism would work. As shown in FIGS. 40A and 40B, a circular prism could be used as well. However, due to the greater height (in the radial direction of the connector) of this particular pin 700 configuration, the wall thickness of the outer body 414 needs to be increased to accommodate such a large pin 700, which makes the connector 410 larger. Also, as shown in FIG. 41, two or more spaced apart pins 700 can also be used in some embodiments. However, unlike the embodiment shown FIGS. 35, the pins would need to be hardened to prevent the pins from bending when the grip ring 590 closes onto them. As such, single, oblong shaped pins are preferred.

As shown in FIGS. 36-39B, the preferred pin 700 configuration fits within a similarly shaped opening 704 in the end nut 418. Furthermore, the pin 700 is arranged to selectively extend into the gap 606 in the gripping ring 590 and to be moved out of the gap 606. In the illustrated construction, the pin 700 is removed from the end nut 418 when it is not needed in the gap 606.

As best shown in FIGS. 37 and 38, the pin 700 has an opening 705 on its exposed end. This opening is engageable by a tool to allow the pin 700 to be removed. In some embodiments, this opening 705 is threaded.

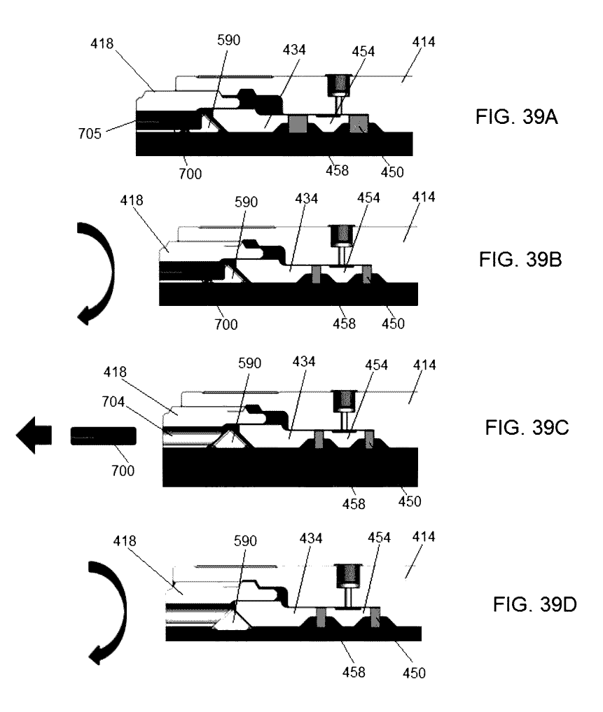

FIGS. 39A-39D illustrate installation of the pipe connector 410 with the stadium prism pin 700. As shown in FIG. 39A, the pipe connector 410 is assembled and ready for installation. As illustrated, the pre-set gap 606 of the assembly 410 is at its maximum with the seals 450 and grip rings 590 clear of the pipe, allowing for pipe insertion without damage. As shown, the pin 700 fills the gap 606 of the grip ring 590 (circumferentially), but is not necessarily in compressive engagement with the grip ring 590. Rather, the pin 700 is generally loosely engaged in the end nut 418 at this point. However, in some embodiments, the pin 700 can be frictionally engaged with the grip rings 590 prior to installation.

As shown in FIG. 39B, the end nut 418 is initially turned or torqued to start the sealing process. The end nut 418 rotates and advances, pushing the seal ram 434 into the seal(s) 450, compressing the seal(s) 450 slightly (e.g., to about 1 tonne-force). During this period, the gripping ring 590 closes down onto the pin 700 and cannot radially compress any further to engage and grip the pipe (not shown). Thereafter, the end nut 418 continues to rotate and advance, and the seal 450 continues to compress. At this point, a seal has been achieved, but pipe grip has not yet begun.

As shown in FIG. 39C, with the seal(s) 450 at the correct compression, the pin 700 is removed. In particularly, activation is halted and activation equipment is drawn clear of the connector so that pin 700 can be removed. A threaded tool can be inserted into the aperture 705 of the pin 700 to allow for easier removal from the grip ring 590.

As shown in FIG. 39D, with the pin 700 removed, the activation equipment can be reattached to the connector 410 and torque can be further applied to the end nut 418. The end nut 418 is continued to be turned to the previously-described torque level (e.g., once the end nut 418 has moved inwardly by a pre-determined distance or has been tightened to reach a pre-determined level of torque) to activate the gripping ring(s) 590 to engage and grip the pipe while maintaining compression of the seal(s) 450 (i.e., no further seal compression occurs).

Once activation is complete, pre-set gaps are at their minimum. The procedure is then repeated for the opposite end. Finally, the seals 450 can be pressure tested as discussed above.

As described above, the connector 410 is removable from one application (e.g., a first pipeline P) and re-installed or installed onto another application (e.g., another pipeline (not shown)) by simply replacing the seals 450 and re-using the gripping rings 490. To remove the connector 410, the installation process is generally reversed.

The components of the connector 10, 210, 410 are compatible with the material of the pipeline P and with the media carried by the pipeline P. In some constructions, the structural components may be formed of suitable materials, such as, for example, steel, stainless steel, carbon steel, etc.

Although the invention has be described in detail with reference to certain preferred embodiments, variations and modifications exist within the scope and spirit of one or more independent aspects of the invention as described above.

One or more independent features and independent advantages of the invention may be set forth in the claims.

What is claimed is:

1. A pipe connector for connecting pipes in a pipeline, the connector comprising:
an outer body defining a cavity;
a gripping ring supported in the cavity, the gripping ring defining a gap to allow the gripping ring to decrease in diameter; and
an end nut defining a nut bore receiving the gripping ring, a nut engagement surface extending into the nut bore and being engageable with the gripping ring, the end nut being configured to move axially inwardly relative to the outer body to compress and cause the gripping ring to engage one of the pipes.

2. The connector of claim 1, wherein the gripping ring has a triangular cross-section.

3. The connector of claim 2, wherein the outer body defines an axis, and wherein the gripping ring has a first ring engagement surface extending at an angle relative to the axis and engageable with the nut engagement surface.

4. The connector of claim 1, wherein the outer body provides a radial surface extending into the cavity, and wherein the connector further comprises a seal supported in the cavity between the radial surface and the end nut, the seal being engageable between a component of the connector and the one of the pipes.

5. The connector of claim 4, wherein the seal is engageable between the outer body and the one of the pipes.

6. The connector of claim 4, further comprising an anti-extrusion ring positioned adjacent the seal.

7. The connector of claim 6, wherein the anti-extrusion ring defines a gap to allow the anti-extrusion ring to decrease in diameter to engage the one of the pipes.

8. The connector of claim 4, wherein the seal includes graphite.

9. The connector of claim 4, further comprising a seal ram supported in the cavity, axial inward movement of the end nut causing axial inward movement of the seal ram to compress the seal.

10. The connector of claim 4, wherein the seal is a first seal, and wherein the connector further comprises a second seal in the cavity between the radial surface and the end nut and spaced from the first seal, the second seal being engageable between a component of the connector and the one of the pipes.

11. The connector of claim 1, wherein the end nut threadedly engages the outer body, rotation of the end nut causing axial inward movement of the end nut.

12. The connector of claim 1, further comprising a pin positioned in the gap, wherein the gripping ring has a gap surface at least partially defining the gap, the gap surface being engageable with the pin to limit compression of the gripping ring during movement of the end nut.

13. The connector of claim 12, wherein the pin is adjustably supported by the end nut.

14. The connector of claim 12, further comprising a seal supported in the cavity, the seal being engageable between a component of the connector and the one of the pipes, axial inward movement of the end nut causing compression of the seal, wherein the pin is supported for movement out of the gap, and wherein the end nut and the gripping ring are configured such that, after compression of the seal and after movement of the pin out of the gap, further axial inward movement of the end nut relative to the outer body compresses and causes the gripping ring to engage the one of the pipes.

15. A method of assembling a pipe connector to at least one pipe in a pipeline, the connector including an outer body defining a cavity, a gripping ring supported in the cavity, the gripping ring defining a gap, and an end nut defining a nut bore receiving the gripping ring, a nut engagement surface extending into the nut bore and being engageable with the gripping ring, the method comprising:
inserting a first pipe into the connector; and
moving the end nut axially inwardly relative to the outer body to compress and cause the gripping ring to engage the at least one first pipe.

16. The method of claim 15, wherein the outer body provides a radial surface extending into the cavity, wherein the connector further includes a seal in the cavity between the radial surface and the end nut and a seal ram supported in the cavity, the seal ram extending at least partially into the nut bore, and wherein the method further comprises moving the seal ram axially inwardly relative to the outer body by axial inward movement of the end nut to compress the seal between a component of the connector and the at least one pipe.

17. The method of claim 15, wherein the gripping ring has a gap surface at least partially defining the gap, wherein the connector further includes a pin, and wherein the method further comprises:
positioning the pin in the gap; and
engaging the gap surface with the pin to limit compression of the gripping ring during movement of the end nut.

18. The method of claim 17, wherein the outer body provides a radial surface extending into the cavity, wherein the connector further includes a seal in the cavity between the radial surface and the end nut, the seal being engageable between a component of the connector and the at least one pipe, and wherein the method further comprises, before moving the end nut axially inwardly relative to the outer body to compress and cause the gripping ring to engage the at least one pipe, moving the end nut axially inwardly relative to the outer body to compress the seal.

19. The method of claim 18, further comprising, after moving the end nut axially inwardly relative to the outer body to compress the seal, moving the pin out of the gap, and wherein moving the end nut axially inwardly relative to the outer body to compress and cause the gripping ring to engage the at least one pipe includes further moving the end nut relative to the outer body to compress and cause the gripping ring to engage the at least one pipe.

20. A method of assembling a pipe connector to at least one pipe in a pipeline, the connector including an outer body defining a cavity and providing a radial surface extending into the cavity, a gripping ring supported in the cavity, the gripping ring defining a gap, an end nut defining a nut bore receiving the gripping ring, a nut engagement surface extending into the nut bore and being engageable with the gripping ring, a pin positionable in the gap to selectively prevent compression of the gripping ring, a seal in the cavity between the radial surface and the end nut, and a seal ram supported in the cavity, the seal ram extending at least partially into the nut bore, the method comprising:
inserting a first pipe into the connector;
moving the end nut axially inwardly relative to the outer body to cause the gripping ring to engage the seal ram without compressing the gripping ring toward the first pipe;
moving the seal ram axially inwardly relative to the outer body by axial inward movement of the end nut to compress the seal between a component of the connector and the first pipe;
thereafter, removing the pin from the gap; and
thereafter, moving the end nut axially inwardly relative to the outer body to compress and cause the gripping ring to engage the first pipe.
